(19) United States
(12) Patent Application Publication
(10) Pub. No.: US 2026/0355698 A1
(43) Pub. Date: Nov. 12, 2026

(54) Manufacturing Bipolar Membranes

(71) Applicant: Captura Corp., Pasadena, CA (US)

(72) Inventors: Sharon Perl Olshvang, Atco, NJ (US); Soomin Kim, Thousand Oaks, CA (US); Jongyeob Jeon, Temple City, CA (US); Eowyn Lucas, Monrovia, CA (US); Michael Lichterman, Pasadena, CA (US); Sreevalli Bokka, Montebello, CA (US); Chengxiang Xiang, San Marino, CA (US)

(73) Assignee: Captura Corp., Pasadena, CA (US)

(21) Appl. No.: 19/671,748

(22) Filed: May 8, 2026

Related U.S. Application Data
(60) Provisional application No. 63/803,368, filed on May 9, 2025.

(51) Int. Cl. B01D 69/12; B01D 61/44; B01D 67/00

(52) U.S. Cl. CPC B01D 69/1216; B01D 61/445; B01D 67/0011; B01D 67/0095; B01D 2311/2623; B01D 2325/04

(57) ABSTRACT

In a general aspect, methods and systems for fabricating bipolar membranes are described. In some implementations, a bipolar membrane includes a first ion-exchange layer, a second ion-exchange layer, and a water-dissociation catalyst layer dispersed between the first ion-exchange layer and the second ion-exchange layer. A roll-to-roll manufacturing method for fabricating the bipolar membrane includes advancing a substrate through a plurality of coating and drying stations; applying a first precursor solution on a surface of the substrate; drying the first precursor solution to form the first ion-exchange layer comprising fixed charges of a first polarity; applying a catalyst ink on a surface of the first ion-exchange layer; drying the catalyst ink to form the water-dissociation catalyst layer; applying a second precursor solution on the water-dissociation catalyst layer; and drying the second precursor solution to form the second ion-exchange layer comprising fixed charges of a second, distinct polarity.

### CROSS-REFERENCE TO RELATED APPLICATIONS

This application claims priority to U.S. Provisional Patent Application No. 63/803,368, filed May 9, 2025, entitled “Manufacturing Bipolar Membranes.” The above-referenced priority document is incorporated herein by reference.

### TECHNICAL FIELD

The following description relates to manufacturing bipolar membranes.

### BACKGROUND

Bipolar membranes (BPMs) are multilayer ion-exchange membranes that typically include an anion-exchange layer (AEL), a cation-exchange layer (CEL), and a water-dissociation catalyst dispersed at or near a junction between the AEL and CEL. BPMs have been used in a wide range of electrochemical technologies and applications, for example, water electrolysis, carbon dioxide reduction, electrodialysis, direct ocean capture, acid/base generation, and electrochemical energy-conversion systems.

### BRIEF DESCRIPTION OF THE DRAWINGS

FIG. 1 is a schematic diagram showing aspects of an example BPM.

FIG. 2 is a schematic diagram showing aspects of an example roll-to-roll (R2R) fabrication system for fabricating the example BPM in FIG. 1.

FIG. 3 is a flow chart showing aspects of an example fabrication process for fabricating the example BPM in FIG. 1.

FIG. 4A is a flow chart showing aspects of an example fabrication process for fabricating the example BPM in FIG. 1.

FIG. 4B is a flow chart showing aspects of an example fabrication process for fabricating the example BPM in FIG. 1.

FIGS. 5A-5C are schematic diagrams showing aspects of example BPMs.

FIG. 6 is a flow chart showing aspects of an example fabrication process for fabricating the example BPMs in FIGS. 5A-5C.

FIGS. 7A-7B include plots showing voltage, in units of Volts (V), as a function of current density, in units of Amperes per square meter (A m⁻²) measured in an electrochemical cell with an example BPM.

FIG. 7C is a plot showing voltage, in units of Volts (V), as a function of time, in units of hours.

FIG. 7D is a plot showing a voltage per triplet in units of Volts (V), as a function of time, in units of hours.

FIG. 8 is a table showing a list of example properties of BPMs.

FIG. 9A is a schematic diagram showing aspects of an example electrodialysis unit.

FIG. 9B is a schematic diagram showing aspects of an example electrochemical cell.

### DETAILED DESCRIPTION

In some aspects of what is described here, a bipolar membrane (BPM) having multiple layers is formed using a multilayer casting process. In some implementations, the BPM includes an anion-exchange layer (AEL), a cation-exchange layer (CEL), and a water-dissociation catalyst layer disposed between the AEL and CEL. The water-dissociation catalyst layer may be dispersed at or near a junction between the AEL and CEL. The BPM can be used in a variety of applications, including, for example, electrochemical systems for acid/base generation, electrodialysis, water electrolysis, carbon dioxide reduction, direct ocean capture (DOC), energy conversion, and other types of electrochemical processes. In some implementations, the BPM is manufactured by a roll-to-roll process on a substrate to provide a fully laminated membrane that can be separated from the substrate and handled as a single sheet. In some examples, the BPM is free of added junction adhesives and may be freestanding or include a structural support.

In some implementations, the systems and techniques described here provide technical advantages and improvement, for example, in the manufacturing, performance, or other aspects of bipolar membranes. For example, the techniques can enable continuous fabrication of BPMs on a flexible substrate with control over layer thickness, catalyst distribution, residual solvent content, and interfacial integrity, thereby supporting scalable and cost-effective production. In some cases, BPMs produced using the techniques described here can provide low electrical resistance, stable water-dissociation performance, good mechanical robustness, and dry-state handling or storage prior to use. In some implementations, these characteristics can improve electrochemical processes that use BPMs for ion separation and for generation and maintenance of acidic and basic environments.

In some implementations, the systems and techniques described here provide advantages in manufacturing, handling, and deployment of BPMs. For example, the multilayer casting and roll-to-roll processes described here can provide control over layer thickness, catalyst distribution, residual solvent content, and interfacial integrity while enabling scalable fabrication on a flexible substrate, e.g., a flexible plastic substrate, a flexible metal substrate, etc. In some implementations, the resulting BPM is a fully laminated membrane that is free of added junction adhesives and can be separated from the substrate as a mechanically robust sheet. In some instances, the BPM is stable in a dry form after fabrication and may be wound, packaged, stored, transported, and later assembled into an electrochemical stack without requiring continuous storage in water or electrolyte. This dry-form handling can simplify manufacturing logistics and storage relative to membranes that are maintained in a hydrated state prior to use.

In some implementations, the BPMs described here also provide favorable electrochemical and mechanical performance characteristics. For example, the BPMs can exhibit low operating voltage for water dissociation, stable operation over extended periods, high current efficiency, controlled thickness, matched swelling behavior, and resistance to delamination, curling, warping, and other dimensional instability. In some examples, a BPM prepared using the techniques described here can have a thickness of less than or equal to 100 μm, a water-dissociation voltage of about 0.95 V at 800 A/m², a current efficiency greater than 95% at 800 A/m², and stable operation for hundreds to thousands of hours.

In some instances, the BPMs described here may be used in a variety of applications and technologies. For example, the BPMs may be incorporated into electrodialysis systems for onsite acid and base generation, electrochemical stacks for water electrolysis or carbon dioxide reduction, direct ocean capture systems, water-treatment systems, chemical-processing systems, and acid/base energy-storage or energy-conversion systems. In some implementations, acidic and basic streams generated using the BPMs may be used directly in a process, stored for later use, or recombined to recover electrical energy.

In some implementations, one or more of the BPMs described here can be incorporated into an electrochemical stack including multiple ion-exchange membranes arranged between electrodes. The electrochemical stack may be configured as an electrodialysis stack, an acid/base storage battery, or another electrochemical device in which water dissociation at the BPM is used to generate and maintain acidic and basic compartments during charge, discharge, or ion-separation operation. In some examples, the electrochemical stack includes one or more BPMs together with AEMs, CEMs, spacer layers, electrodes, and flow channels.

In some implementations, the BPMs described here are configured for operation under chemically demanding conditions, for example in acidic and basic environments and at elevated temperatures. Selection of the ion-exchange polymers, residual solvent content, catalyst composition, layer thicknesses, and any optional structural support can improve resistance to delamination, excessive swelling, dimensional instability, and loss of performance during fabrication, storage, and operation.

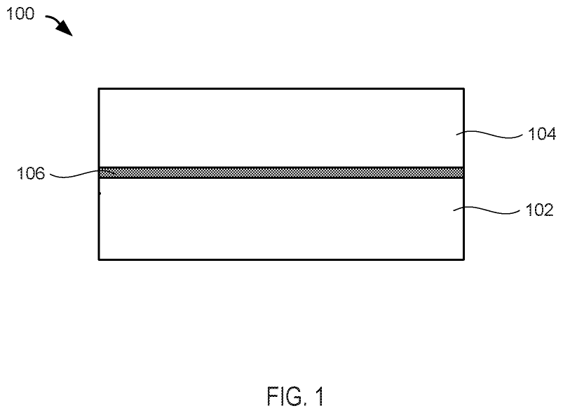

FIG. 1 is a schematic diagram showing aspects of an example BPM 100. As shown in FIG. 1, the example BPM 100 is a composite membrane composed of three distinctive layers. The example BPM 100 includes a first ion-exchange layer 102, a second ion-exchange layer 104, and a water-dissociation catalyst layer 106 sandwiched between the first and second ion-exchange layers 102/104. In some instances, the water-dissociation catalyst layer is not a distinct or continuous layer separating the first and second ion-exchange layers 102,104. For instance, the water-dissociation catalyst layer 106 may be distributed or dispersed at the junction between the first and second ion-exchange layers 102, 104.

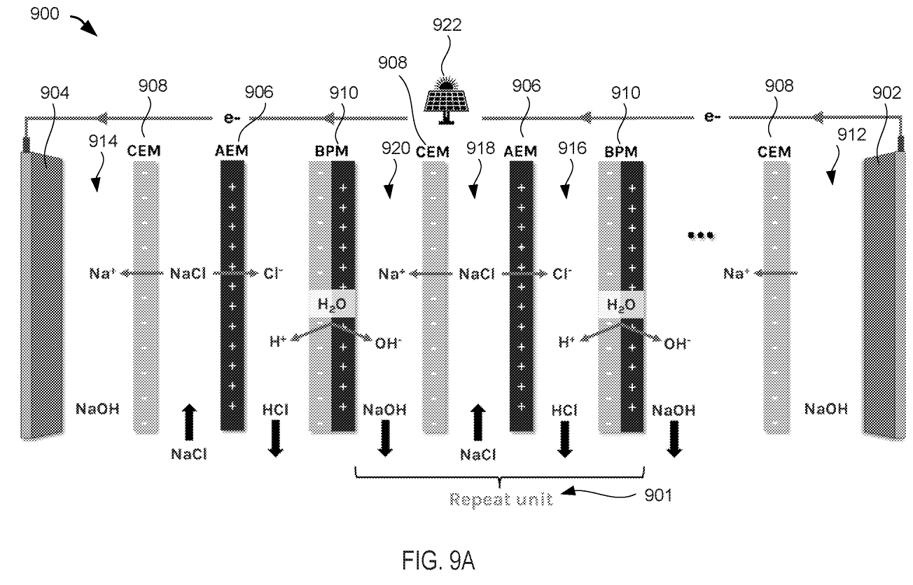

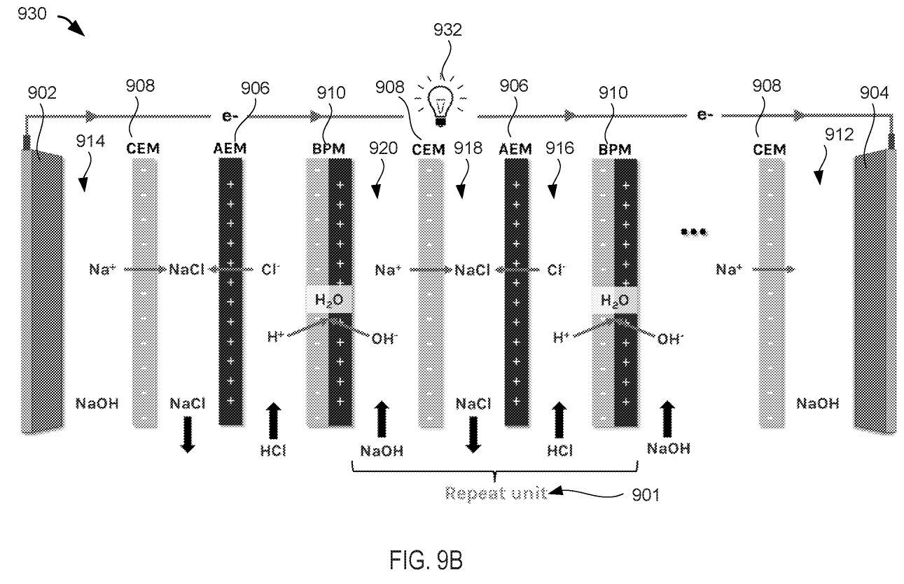

Water dissociation using the BPM 100 is useful in multiple electrochemical applications such as acid and base production, waste stream and resource recovery, and water electrolysis. In some instances, the BPM 100 can be freestanding when used in an electrodialysis unit (e.g., the electrochemical cell 900, 930 in FIGS. 9A-9B) without external support.

In some implementations, the first ion-exchange layer 102 includes a first ion-exchange material containing fixed charges of a first polarity; and the second ion-exchange layer 104 includes a second ion-exchange material containing fixed charges of a second, opposite polarity. For example, the first ion-exchange layer 102 may be an anion-exchange layer (AEL) containing fixed positive charges; and the second ion-exchange layer 104 may be a cation-exchange layer (CEL) containing fixed negative charges. For another example, the first ion-exchange layer 102 may be a CEL containing fixed negative charges; and the second ion-exchange layer 104 may be an AEL containing fixed positive charges.

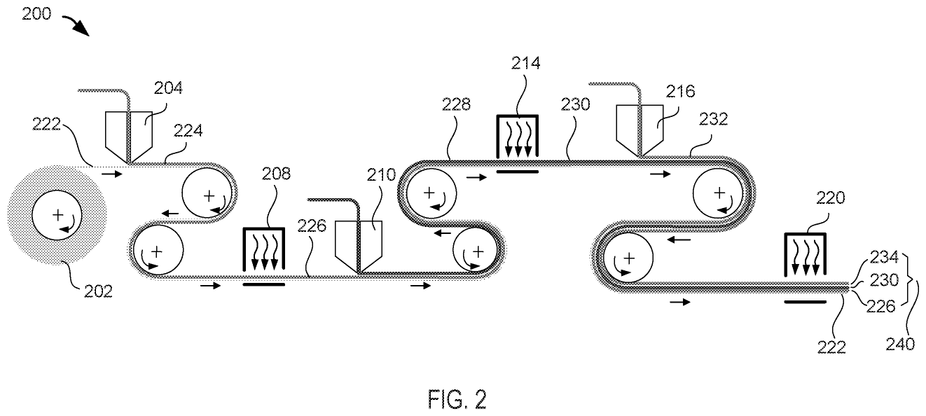

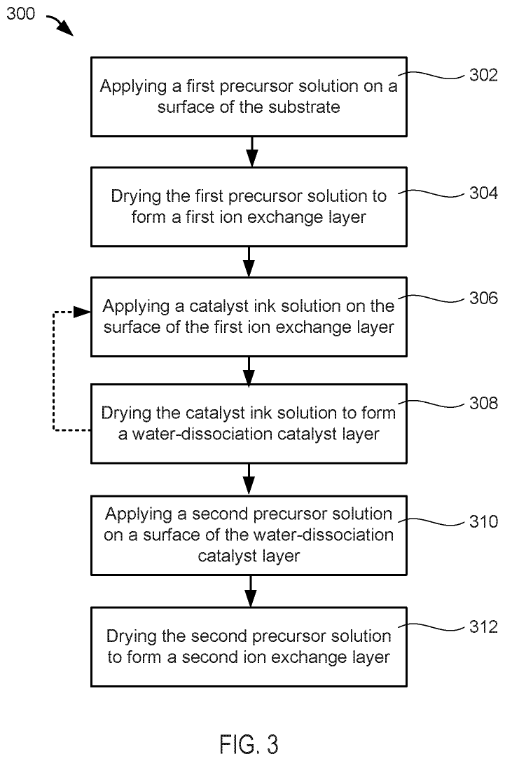

In some instances, a variety of materials can be used as the first and second ion-exchange materials. In some instances, the first and second ion-exchange materials may include polysulfones, polyetheretherketone (PEEK), polyimides, polystyrene, polyarylene, polyolefin, or other polymer material. In some instances, the BPM 100 can be prepared by performing a multi-layer casting method, a roll-to-roll manufacturing process on a surface of a substrate, or another method. In some instances, the example BPM 100 can be prepared using the operations of the example processes 300, 400, 420, 600 in FIGS. 3, 4A-4B, 6 using the example manufacturing system 200 in FIG. 2 or in another manner.

In some instances, chemical stability of the ion-exchange materials is required when selecting the ion-exchange materials for the first and second ion-exchange layers 102, 104. High chemical stability can prevent delamination of the first and second ion-exchange layers 102, 104 during prolonged operation cycles of the BPM 100. In some implementations, the first ion-exchange material of the first ion-exchange layer 102 may be an AEL which is stable in alkaline solutions; and the second ion-exchange material of the second ion-exchange layer 104 may be a CEL which is stable in acidic solutions.

In some instances, the water-dissociation catalyst layer 106 may include one or more transition metal oxides, oxyhydroxide, hydroxide, non-metal catalyst, or combination. In some instances, electrostatic forces due to electrically charged groups in the catalyst material can also improve adhesion between the first and second ion-exchange layers 102, 104 and prevent delamination. When biased under an external potential in an electrochemical stack, the water-dissociation catalyst layer 106 is configured to expedite water dissociation into H⁺ and OH⁻ at the junction between the first and second ion-exchange layers 102, 104. In some implementations, the water-dissociation catalyst layer 106 in the BPM 100 is 0.01-10 grams per square meter (GSM).

In some implementations, BPM 100 may include a structural support disposed in at least one of the first and second ion-exchange layers 102, 104. For example, one or more structural support may be embedded within the first ion-exchange layer 102, embedded within the second ion-exchange layer 104, or arranged such that respective portions of the structural support extend into both the first and second ion-exchange layers 102, 104. In some implementations, the structural support may be a reinforcement mesh, a woven layer, a nonwoven layer, a porous fluoropolymer layer, a microporous polymer scaffold, or another porous support structure that is at least partially impregnated or filled with ion-exchange material of the at least one corresponding ion-exchange layer 102, 104. In some implementations, a structural support is configured to provide mechanical reinforcement to the BPM 100, for example by increasing tensile strength, improving dimensional stability, reducing creep, reducing shrinkage or expansion during hydration and dehydration, and facilitating handling during manufacture, storage, and assembly, while permitting the BPM 100 to maintain ionic conductivity and a relatively low overall thickness. In some instances, the structural support may include polytetrafluoroethylene (ePTFE), polypropylene (PP), ultra-high-molecular weight polyethylene (UHMWPE), and polyethylene (UHDPE), polyetheretherketone, or another high-density material.

In some implementations, the BPM 100 has a physical thickness, measured through the thickness direction from one outer surface of the membrane to the opposite outer surface, of less than 200 μm, less than 100 μm, in a range of 20 to 100 μm, or in a range of 40 μm to 80 μm. In some implementations, a thickness of less than or equal to 100 micrometers is significant because membrane thickness can affect ionic resistance, operating voltage, and overall electrochemical performance of the BPM. For example, reducing the overall thickness of the BPM can decrease ionic resistance through the membrane and thereby reduce the voltage required to sustain a selected current density. In some implementations, maintaining the BPM at less than or equal to 100 micrometers can provide improved electrochemical voltage efficiency while still preserving sufficient mechanical robustness, interfacial integrity, and handling characteristics for fabrication, storage, transport, and use in an electrochemical stack In some implementations, the overall physical thickness of the BPM 100 may correspond to the combined thicknesses of the first and second ion-exchange layers 102, 104, and an intervening water-dissociation catalyst layer 106 together with any thickness contribution from an embedded support or reinforcement structure. In some implementations, the physical thickness of each ion-exchange layer of the BPM 100, for example the anion-exchange layer and the cation-exchange layer, is independently selected to provide the desired ionic resistance, mechanical integrity, and water-dissociation performance, and each such layer may have a thickness in a range of 5 μm to 95 μm. In some implementations, one ion-exchange layer is thinner than the other, for example such that the thickness of the thinner ion-exchange layer is 10% to 100% of the thickness of the thicker ion-exchange layer, or 20% to 40% of the thickness of the thicker ion-exchange layer. In some instances, the first and second ion-exchange layers 102, 104 may have the same thickness. Unless otherwise specified, the foregoing thicknesses may refer to the BPM 100 in a dry state.

In some implementations, the relative thicknesses of the first and second ion-exchange layers 102, 104 are also selected to promote mechanical stability and operational performance. For example, the ratio between the thickness of the first ion-exchange layer 102 and the thickness of the second ion-exchange layer 104 may be in a range of 1:9 to 9:1. In some instances, one of the ion-exchange layers may be thinner than the other to reduce resistance, adjust water transport, or increase the electric field at the interface, while the other layer provides additional mechanical robustness. In some implementations, the thicknesses and swelling properties of the first and second ion-exchange layers 102, 104 are selected together such that the BPM 100 remains intact and mechanically robust even as the membrane is repeatedly hydrated, subjected to an electric field, and exposed to pressure, flow, and chemical gradients within an electrodialysis stack or another electrochemical stack. As a result, the BPM 100 can maintain adhesion or interfacial integrity between the first and second ion-exchange layers 102, 104, resist delamination and rupture, and provide stable water-dissociation performance over extended use. In certain examples, selection of the total thickness, the thickness of each individual ion-exchange layer, and the thickness ratio between the first and second ion-exchange layers 102, 104 can be used to balance ionic resistance, interfacial electric-field strength, water transport, and mechanical robustness.

As used herein, an amount expressed in weight percent (wt %) for a component of a composition, mixture, solution, ink, dispersion, layer, membrane, or other material is the mass of that component divided by the total mass of the composition, mixture, solution, ink, dispersion, layer, membrane, or other material being measured, multiplied by 100. Thus, for example, when an ion-exchange material is described as being present in a precursor solution at a specified wt %, the wt % is the mass of the ion-exchange material relative to the total mass of the precursor solution; when a water-dissociation catalyst material is described as being present in a catalyst ink at a specified wt %, the wt % is the mass of the water-dissociation catalyst material relative to the total mass of the catalyst ink; and when an ion-exchange layer is described as having a residual solvent content of less than a specified wt %, the wt % is the mass of residual solvent remaining in the ion-exchange layer relative to the total mass of that ion-exchange layer, including solid constituents and residual solvent, at the time of measurement. Unless otherwise specified, the wt % is based on the material in the state in which it is being characterized.

In some implementations, BPM 100 includes residual solvent. In other words, at least a portion of the residual solvent used to dissolve the ion-exchange materials during the formation of the first and second ion-exchange layers 102, 104 remains in the BPM 100 after formation of the respective ion-exchange layers 102, 104. For example, the first and second ion-exchange materials in the forms of polymer powders or ionomers can be dissolved or suspended in one or more solvent. In some instances, the first and second ion-exchange materials may include polysulfones, polyetheretherketone, polyimides, polystyrene, polyarylene, polyolefin, or another polymer. In some instances, solvents that can be used for dissolving the first and second ion-exchange materials may include polar, protic and aprotic solvents such as N,N-dimethylacetamide (DMAc), N-methyl-2-pyrrolidone (NMP), Dimethyl Sulfoxide (DMSO), MeOH, Ethanol 1-Propanol, 2 Propanol, Dimethyl carbonate (DMC), Methyl Ethyl Ketone (MEK), 1,4-Dioxane, Tetrahydrofuran (THF) as well as non-polar solvents such as Cyclohexane. In some instances, the residual solvent content may result from one or more solvents used in forming precursor solutions or ink compositions for the respective layers and may be selected to balance membrane flexibility, mechanical integrity, ionic performance, and handling characteristics. In some implementations, limiting the residual solvent content to less than or equal to a selected amount is significant because the residual solvent content can affect flexibility, dimensional stability, and interfacial integrity of the BPM. For example, when the residual solvent content is too high, the BPM may become excessively soft, tacky, or prone to swelling, creep, deformation, or other dimensional instability. By contrast, maintaining the residual solvent content below the selected level can improve handling, dry-state storage, transportability, and structural stability of the BPM while preserving suitable electrochemical performance after rehydration and use. In some implementations, the residual solvent content of the first ion-exchange layer 102 or the second ion-exchange layer 104 is less than 30 wt %, less than or equal to 20 wt %, less than or equal to 15 wt %, in a range of 5 to 15 wt %, or in another range. In some implementations, the overall concentration of the residual solvent in the BPM 100 is less than or equal to 30 wt %, less than or equal to 20 wt %, in a range of 10 to 20 wt %, or in another range.

In some implementations, a membrane sample, for example a sample having dimensions of about 4 cm by 4 cm, is obtained and weighed on an analytical balance prior to heat treatment to determine an initial sample mass. The membrane sample is then heated at a temperature of about 170 °C for about 1 hour to remove residual solvent from the membrane sample. After heating, the membrane sample is removed from the furnace and weighed again on the analytical balance to determine a post-heating sample mass. In some implementations, the post-heating mass is measured promptly after removal from the furnace to limit moisture reabsorption prior to weighing. A residual solvent content of the membrane sample may then be determined based on the difference between the initial sample mass and the post-heating sample mass. In some instances, the residual solvent content may be determined in another manner.

In some implementations, the BPM 100 is stable in a dry form and does not need to be stored hydrated. In some implementations, after fabrication and drying, the BPM is in a dry form in which the membrane is free of bulk liquid water and can retain a selected residual solvent content and, in some instances, bound moisture. In dry form, the BPM on the substrate may be mechanically robust enough to be wound into roll form, cut into sheets, stacked, packaged, stored, transported, and later separated from the substrate and assembled into an electrochemical stack without requiring continuous hydrated storage. In some implementations, the BPM is stable in a dry form and does not require hydrated storage to preserve usability. In some implementations, the BPM is stable in a dry form and does not require hydrated storage. For example, after fabrication and drying, the BPM may be stored on a shelf, packaged, transported, and handled without being maintained in water, an electrolyte solution, or another hydrating medium. In some implementations, the BPM may remain in a dry state for an extended period of time, for example for days, weeks, or months, without significant degradation of membrane integrity or unacceptable loss of electrochemical performance after later wetting or rehydration.

Before electrochemical operation, the dry-form BPM may be wetted, soaked, or otherwise hydrated with water or an electrolyte solution to convert the BPM to a wet form suitable for ion transport and water-dissociation operation. In some instances, after hydration prior to use, the BPM retains sufficient interfacial integrity, ionic performance, and mechanical robustness for electrochemical operation. In some instances, the BPM may be removed from a hydrated environment, dried, stored in the dry state, and later rewetted or rehydrated for use, while retaining sufficient interfacial integrity, ionic performance, and mechanical robustness for electrochemical operation. In some implementations, such cycling between wet and dry states does not cause unacceptable cracking, embrittlement, curling, delamination, or other damage to the BPM.

In some implementations, the BPM 100 is mechanically stable throughout the electrodialysis process or during other electrochemical processes. During operation, the first and second ion-exchange layers 102, 104 may absorb water and swell as the BPM 100 is hydrated and subjected to water dissociation, ion transport, and exposure to acidic and basic environments on opposite sides of the membrane. In some implementations, the first and second ion-exchange layers 102, 104 are selected such that their hydration behavior is sufficiently similar to maintain structural integrity of the BPM 100 during operation. For example, the first and second ion-exchange layers 102, 104 have substantially comparable expansion ratios when hydrated so that excessive internal stress does not develop across the interface or junction between the two ion-exchange layers 102, 104. In some instances, the swelling characteristics of the first and second ion-exchange layers 102, 104 are closely matched or sufficiently similar to reduce or prevent tension, curling, warping, cracking, mechanical failure, delamination, or other dimensional instability of the BPM 100 during hydration, dehydration, repeated current cycling, or prolonged operation. In some implementations, the ion-exchange materials of the first and second ion-exchange layers 102, 104 are selected such that the swelling of each ion-exchange layer in solution is less than 10%, or another sufficiently low value that supports dimensional stability while maintaining ion conductivity. In this way, matched swelling of the ion-exchange layers can improve interfacial integrity, dimensional stability, and long-term electrochemical performance of the BPM.

In some implementations, the ion-exchange material in each of the ion-exchange layers 102, 104 has a thermal stability which allows better withstanding of drying operations during the manufacturing process, at elevated temperatures that may arise during electrodialysis or other electrochemical processes, and repeated thermal cycling associated with startup, shutdown, or extended operation. In some instances, the thermal stability of the first and second ion-exchange layers 102, 104 can also maintain structural integrity of the BPM 100 during fabrication, storage, and operation. In some instances, the BPM 100 has a thermal stability that can reduce or avoid softening, deformation, shrinkage, or other thermally induced dimensional changes in the first and second ion-exchange layers 102, 104, thereby helping to preserve adhesion and interfacial integrity between the layers. In some instances, thermal stability can also reduce or prevent delamination of the membranes during prolonged operation cycles of BPM 100, particularly where the BPM 100 is exposed to electric fields, and chemically different environments on opposite sides of the membrane. Accordingly, selection of ion-exchange materials having suitable thermal stability can improve durability, dimensional stability, and long-term operational reliability of the BPM 100.

In some implementations, the BPM is used in a wet form after hydration by water or an aqueous electrolyte solution. In a wet form, the ion-exchange layers absorb water, the fixed-charge domains become hydrated, ionic conductivity increases, and water at or near the junction between the ion-exchange layers is available for water dissociation and/or recombination during electrochemical operation. In some implementations, the wet-form BPM has a thickness, modulus, tensile strength, and elongation-to-break measured after soaking in an aqueous solution, for example a sodium chloride solution. In some instances, hydration of the BPM can cause swelling relative to a dry form, and the degree of water uptake and swelling can depend on ion-exchange capacity, polymer composition, residual solvent content, electrolyte composition, temperature, and operating bias. In some implementations, the first and second ion-exchange layers are selected such that the wet-form BPM provides sufficient water uptake and ionic conductivity while limiting excessive swelling, dimensional instability, internal stress, curling, cracking, or delamination during operation. In some implementations, when in a wet form, for example after soaking in a 0.5 M NaCl solution at room temperature for greater than 1 hour to become fully hydrated, the BPM 100 has a Young's modulus in a range of 30 to 1000 MPa, a tensile strength of 15 to 40 MPa, and an elongation to break of 5 to 20%. In some instances, mechanical testing may be performed using an Instron Universal Testing System in accordance with ASTM D882-12. In some implementations, each test specimen has dimensions of about 0.5 inch by 4 inches, the thickness of each specimen is determined from an average of 5 thickness measurements taken at spaced intervals along the specimen, the initial grip separation is 1 inch, and the rate of grip separation is 2.54 mm/min. In some implementations, at least 3 specimens are tested, and 5 specimens may be tested. In some instances, when a specimen initially in a wet form begins to dry during setup, the membrane is rehydrated prior to further testing. Elongation to break may be determined from the last recorded strain percentage for the specimen.

In some implementations, each of the first and second ion-exchange layers 102, 104 can be characterized by one or more material properties selected to provide suitable ion transport, mechanical stability, and compatibility with the manufacturing process. For example, each of the first and second ion-exchange layers 102, 104 may have an ion-exchange capacity (IEC) in a range of 0.5 to 3 milliequivalents per gram (mequiv/g) or another range. In some implementations, the IEC of each ion-exchange layer 102/104 is selected to provide a desired concentration of fixed charge groups in the corresponding ion-exchange material and thereby promote selective transport of ions through the respective ion-exchange layer. For example, the IEC of a CEL corresponds to the concentration of acidic fixed-charge groups, and the IEC of an AEL may correspond to the concentration of basic fixed-charge groups. In some instances, selection of IEC values within the foregoing range can be used to balance ionic conductivity, water uptake, swelling, mechanical robustness, and interfacial performance in BPM 100. In some instances, the IEC of the first and second ion-exchange layers 102, 104 may be selected, independently or together, to provide a combination of ion transport performance and structural stability suitable for electrodialysis and other electrochemical applications.

During operation, electric current can be applied to the BPM 100 using an anode and a cathode. The anode and cathode can have supporting electrolyte solutions such as anolyte and catholyte, respectively. In some implementations, the anode is associated with an anolyte solution; and the cathode is associated with a catholyte solution, where the anolyte and catholyte serve as supporting electrolyte solutions that provide ionic conductivity at the electrode compartments, support the electrochemical reactions occurring at the respective electrodes, and help maintain stable operating conditions for the electrodialysis process. The anolyte and catholyte may each independently include water and one or more dissolved salts, acids, bases, or buffer species, and may be supplied as recirculating streams or replenished streams during operation. When a voltage is applied between the anode and the cathode, an electric field is established across the membrane stack, including across the BPM 100, thereby driving ionic transport through the ion-exchange membranes.

Under a forward bias, water at or near the junction of the oppositely charged ion-exchange layers 102, 104 can dissociate into H⁺ ions and OH⁻ ions, with the H⁺ ions migrating through the cation-exchange layer in a direction toward the cathode and the OH⁻ ions migrating through the anion-exchange layer in a direction toward the anode. In this manner, the BPM 100 can contribute to formation of acidic and basic process streams within adjacent flow channels of the electrodialysis unit. In some implementations, the electrode compartments are hydraulically isolated from the process channels by one or more ion-exchange layers such that products generated at the electrodes remain separated from the acid and base product streams, while the anolyte and catholyte continue to provide electrical coupling between the electrodes and the membrane stack. In some implementations, the BPM 100 may be used in an electrochemical stack in an electrochemical cell for acid and base generation. For example, the BPM 100 may be implemented as the BPM 910 and used in the example electrochemical cell 900 shown in FIG. 9A or in another manner.

Under a reverse bias, ionic current can be carried by H⁺ and OH⁻ ions generated via water dissociation at a junction between the first and second ion-exchange layers 102, 104. The generated H⁺ ions can transport through the CEL; and the generated OH-ions can transport through the AEL. At the junction, mobile protons and hydroxides from the CEL and AEL respectively react to form water, neutralizing the mobile ions to generate a space-charge depletion region of a few nanometers, which can result in a strong electric field on the order of 108 to 109 vm⁻¹. Under reverse bias, the electric field present at the junction accelerates water dissociation via the Second Wien Effect, allowing for enhanced production of H⁺ and OH⁻, which provide ionic currents through the first and second ion-exchange layers 102, 104 and enable buildup of pH gradients across the BPM 100. The water-dissociation catalyst layer 106 at the junction can increase the electric field by accelerating water dissociation. In some implementations, the BPM 100 may be used in an electrochemical stack in an electrochemical cell for energy generation. For example, the BPM 100 may be implemented as the BPM 910 and used in the example electrochemical cell 930 shown in FIG. 9B or in another manner.

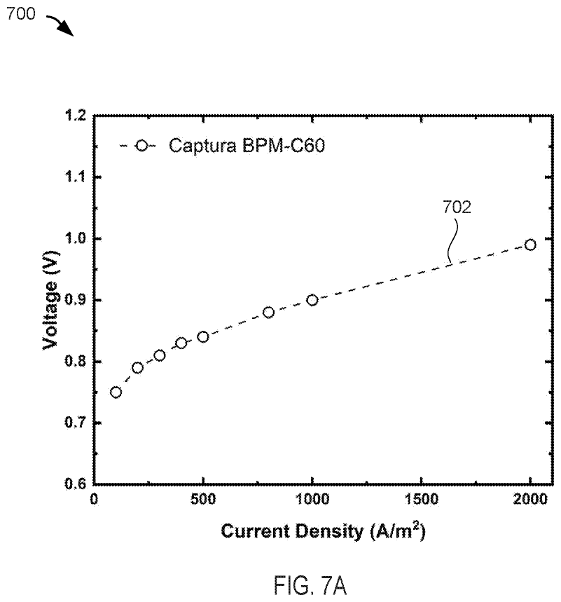

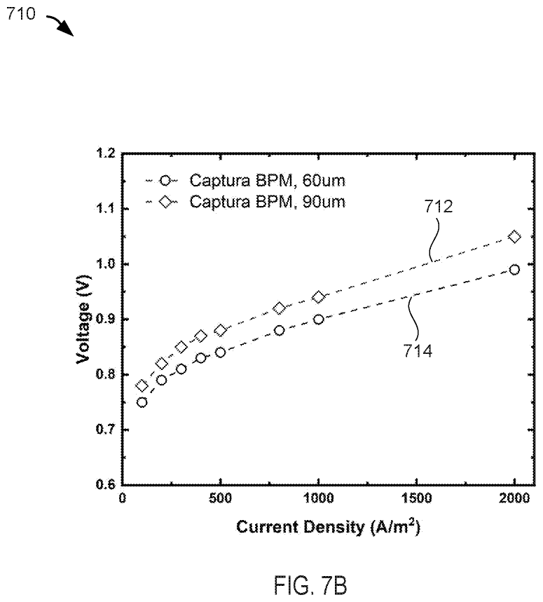

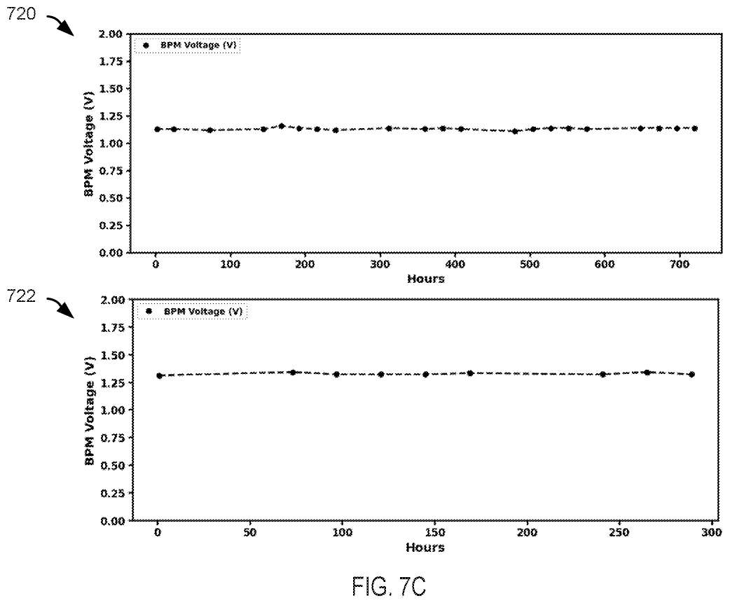

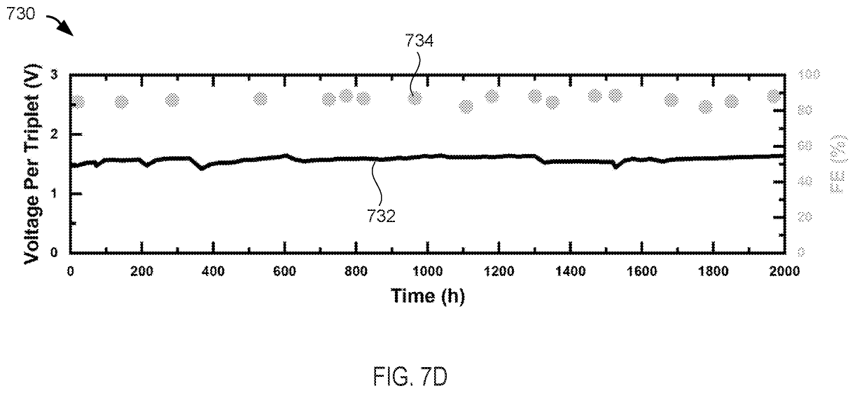

In some instances, the example BPM 100 can be operated at current densities in a range of 100 A/m² to 2000 A/m² (as shown in FIGS. 7A-7B). The example BPM 100 can be operated at voltages lower than or equal to about 1.5 V (as shown in FIGS. 7A-7B). The example BPM 100 exhibits voltage stability at extended periods of time for hundreds or thousands of hours. In certain instances, the BPM 100 can sustain stable voltage at a current density of about 800 A/m² for at least 700 hours (as shown in FIG. 7C) and can sustain stable voltage a current density of about 2000 A/m² for at least 300 hours (as shown in FIG. 7C).

In some implementations, the BPM 100 is a single, fully laminated sheet in which the first ion-exchange layer 102, the second ion-exchange layer 104, and the water-dissociation catalyst layer 106 are integrated into one membrane structure rather than being separately fabricated layers later laminated together. In some implementations, catalyst loading of the water-dissociation catalyst layer 106 refers to the amount of water-dissociation catalyst material present per unit membrane area, for example expressed in grams per square meter (g/m²). In some implementations, the catalyst loading corresponds to the dry mass of the catalyst material distributed at the junction between the first and second ion-exchange layers 102, 104 divided by the corresponding membrane area. In some implementations, the water-dissociation catalyst layer 106 has a catalyst loading in a range of 0.01 to 5 g/m², which can provide a balance between water-dissociation activity and low interfacial resistance

In some implementations, the BPM 100 is free of added junction adhesives and is physically uniform in appearance and construction, for example with substantially uniform color, texture, and thickness across the sheet. In some implementations, the fabrication process is controlled to limit excessive variation in thickness, surface roughness, wrinkling, streaking, pinholes, agglomeration, or other local non-uniformities, thereby providing a mechanically robust membrane with consistent handling characteristics and electrochemical performance.

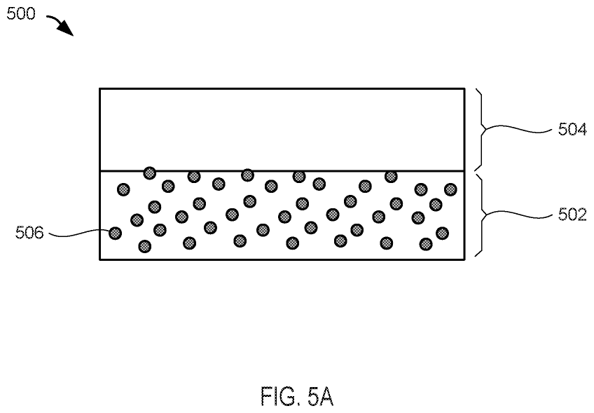

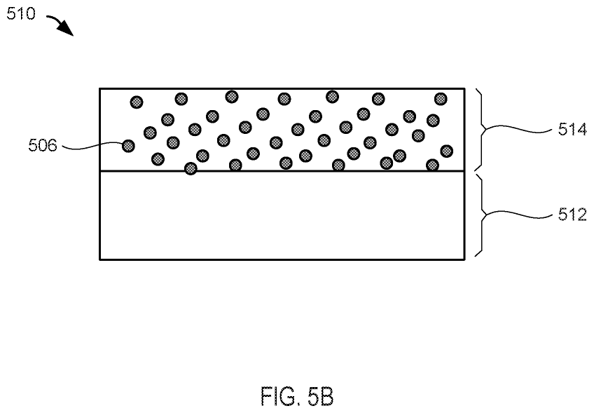

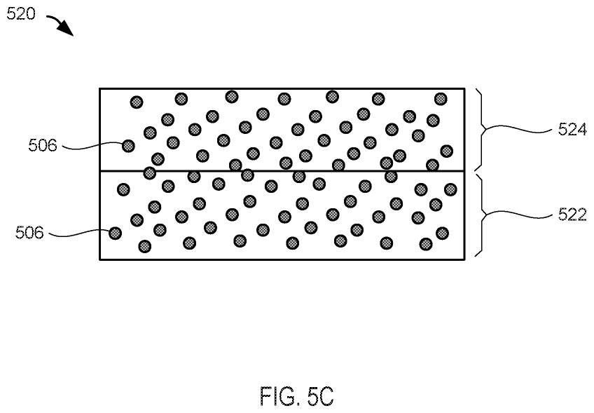

FIG. 2 is a schematic diagram showing aspects of an example fabrication system 200. In some instances, the fabrication system 200 is a roll-to-roll fabrication system which can be used to perform operations of process 300, 400, 420, 600 in FIGS. 3, 4A-4B, and 6 to manufacture the example BPM 100, 500, 510, 520 shown in FIGS. 1, 5A-5C or another multilayered conductive polymer. In some implementations, the fabrication system 200 is configured to enable repeated and scalable fabrication of high-performance BPMs with controlled layer thickness, catalyst loading, residual solvent content, interfacial integrity, and mechanical uniformity. The fabrication system 200 may include, for example, one or more unwind stations, web handling and alignment components, substrate cleaning and activation units, one or more coating stations, one or more drying stations, chill rollers, inspection devices, rewinding stations, and a control system configured to coordinate operation of the various stations. The example fabrication system 200 may include additional or different features, and the components of the fabrication system 200 may operate as described with respect to FIG. 2 or in another manner.

As shown in FIG. 2, the example fabrication system 200 includes an unwinder roll station 202 configured to feed a flexible substrate 222 into downstream fabrication processes. In some implementations, the flexible substrate 222 is supplied as a continuous sheet and is advanced through the fabrication system 200 under controlled tension. In some implementations, the flexible substrate 222 is a flexible substrate that can be wound, unwound, and conveyed through the fabrication system 200 as a continuous web. For example, the flexible substrate 222 may include a flexible plastic substrate, a flexible metal substrate, a metal foil, a composite substrate, a treated paper substrate, or another bendable sheet material. In some implementations, the flexible substrate 222 has sufficient dimensional stability and surface integrity to support coating and drying of the membrane layers while also permitting later separation of the formed BPM from the substrate.

The unwinder roll station 202 may include one or more web tension control devices, brakes, drive rollers, edge-guiding devices, alignment rollers, dancer rollers, load cells, and web-position sensors configured to maintain lateral alignment and tension of the substrate 222 during coating and drying operations. In some implementations, the substrate 222 includes a release substrate or temporary carrier substrate configured to support formation of the multilayer ion-conductive polymer and permits subsequent separation of the formed membrane from the substrate. In some instances, the substrate 222 may be or include a polymer film, a fluoropolymer-coated substrate, a metal foil, a treated paper, a composite carrier, a metal foil, or another flexible sheet material. In some implementations, a reinforcement structure, such as a reinforcement mesh, woven layer, nonwoven layer, porous fluoropolymer layer, or microporous polymer scaffold, may also be fed into the process with the substrate 222 or disposed on the substrate 222 after coating, for example to become embedded in one or both ion-exchange layers.

As shown in FIG. 2, the fabrication system 200 further includes a first coater 204 configured to deposit a first precursor solution 224 onto the surface of the substrate 222. In some implementations, the first coater 204 is or includes a slot-die coater, doctor blade, Mayer rod, Bird bar, roller coater, knife-over-roll coater, gravure coater, reverse-roll coater, comma coater, spray coater, or another film-casting device configured to form a substantially continuous liquid film. The first precursor solution 224 may be delivered to the first coater 204 by one or more pumps, for example a peristaltic pump, gear pump, syringe pump, diaphragm pump, or another metering pump. In some implementations, the first coater 204 includes a coating-head alignment system and one or more controls for adjusting coating gap, coating width, solution feed rate, substrate speed, and wet-film thickness. In some implementations, the first precursor solution 224 includes a first ion-exchange material with a concentration in a range of 1 to 50 wt %, 5 to 40 wt %, 10 to 30 wt %, or another suitable range, and has a viscosity in a range of 100 to 12000 cP, 200 to 10000 cP, 500 to 8000 cP, 1500 to 3000 cP, 2500 to 6000 cP, or another suitable range. In some implementations, the concentration and viscosity ranges for the first precursor solution are beneficial because they provide a suitable process window for coating and drying the first ion-exchange layer. For example, a concentration of 10 to 50 wt % and a viscosity of 500 to 8000 cP can enable formation of a stable wet film with controlled thickness and reduced coating defects, while also supporting formation of a mechanically robust first ion-exchange layer suitable for subsequent multilayer fabrication. The first precursor solution 224 may include polar, protic and aprotic solvents such as N,N-dimethylacetamide (DMAc) and N-methyl-2-pyrrolidone (NMP), Dimethyl Sulfoxide (DMSO), MeOH, Ethanol, 1-Propanol, 2 Propanol, Dimethyl carbonate (DMC), 1,4-Dioxane, Methyl Ethyl Ketone (MEK), Tetrahydrofuran (THF), as well as non-polar solvents such as Cyclohexane.

In some implementations, the first precursor solution 224 on the substrate 222 forms a wet precursor film that is subsequently dried in a first drying station 208. The first drying station 208 may include, for example, a hot-air convection oven, infrared heater, near-infrared lamp, heated tunnel, vacuum-assisted dryer, or multi-zone drying chamber. In some implementations, the first drying station 208 includes multiple independently controlled drying zones configured to control solvent evaporation rate, polymer solidification, and residual solvent content while limiting cracking, curling, bubbling, wrinkling, skin formation, or non-uniform thickness. After passage through the first drying station 208, the first precursor solution 224 deposited on the surface of the substrate 222 is converted to a first ion-exchange layer 226, and at least a portion of the substrate 222 is coated with the first ion-exchange layer 226. In some implementations, the first ion-exchange layer 226 may be an AEL or a CEL with residual solvent.

As shown in FIG. 2, the fabrication system 200 further includes a second coater 210 configured to deposit a catalyst ink 228 onto the surface of the first ion-exchange layer 226. In some implementations, the second coater 210 may be implemented in a manner similar to the first coater 204 or may be selected independently based on the properties of the catalyst ink 228. For example, the second coater 210 may include a slot-die coater, doctor blade, rod coater, Bird bar, spray coater, or another film-casting device configured to apply a substantially continuous catalyst-containing film with a controlled wet thickness and coating width. The catalyst ink 228 may be delivered to the second coater 210 using one or more pumps, for example a peristaltic pump, gear pump, or other metering pump, and the second coater 210 may include a coating-head alignment system and one or more controls for coating gap, coating width, feed rate, and relative web position. In some implementations the catalyst material in the catalyst ink 228 may include a water complex of one or more of the following, transition metal oxide, oxyhydroxide, hydroxide, or non-metal or combination. In some implementations, the water in the catalyst ink may be 1-40 wt %. In some implementations, the solvent in the catalyst ink includes IPA, which can be in a range of 1 to 97 wt %. In some instances, the catalyst ink 228 can also include other organic solvents, such as DMAc, NMP, methanol, ethanol, etc. In some instances, the non-ionic hydrophilic surface-active agent in the catalyst ink 228 may include PEG, polysorbats, nonoxynol, pluronics, PGs, PPG, NP-40 Surfact-Amps™ detergent solution, Sorbitan, Tween® 80, etc. up to 15 wt %. In some instances, the dispersing agent such as Solsperse™ SW320, Solsperse™ 45000, Efka® PX 4733, Dispex® Ultra CX 4452, etc. up to 15 wt %. In some instances, the rheology modifier such as Poly acrylates, Carbopol® 940, Solthix™ A100 in the catalyst ink could be up to 15 wt %. The catalyst material to water ratio in the catalyst ink solution is in a range of 1:2 to 1:20. In some instances, the first or second ion-exchange material or ionomer is up to 10%. In some implementations, such content in the catalyst ink is beneficial because it can improve coating quality and adhesion between the catalyst-containing region and the adjacent ion-exchange layers while preserving the catalytic character of the catalyst ink. In some instances, the additives such as surface-active agent, dispersing agent or rheology modifier or combination can be up to 15 wt %. In some implementations, the catalyst ink has a viscosity in a range of 5 to 250 cP; and the pH value of the catalyst ink is in a range of 1 to 11. In some implementations, such viscosity and pH ranges for the catalyst ink are beneficial because they provide a suitable processing window for stable coating and drying of the catalyst-containing composition. As a result, the catalyst-containing region can be formed with improved uniformity, interfacial integrity, and electrochemical performance. In some instances, the catalyst ink 228 may further include the first ion-exchange material, the second ion-exchange material, or both, such that the resulting water-dissociation catalyst layer may be formed as a distinct intermediate layer or may be partially distributed into one or both adjacent ion-exchange layers.

As shown in FIG. 2, the fabrication system 200 further includes a second drying station 214 disposed downstream of the second coater 210. In some implementations, the second drying station 214 is configured to remove at least a portion of water and one or more organic solvents from the catalyst ink 228 so that the catalyst material remains deposited at or near the surface of the first ion-exchange layer 226. The second drying station 214 may be implemented as a hot-air convection oven, infrared heater, vacuum dryer, drying tunnel with one or more temperature zones, or another drying device.

In some implementations, the second drying station 214 is operated under drying conditions selected to form a substantially continuous water-dissociation catalyst layer 230 while limiting agglomeration, cracking, dewetting, non-uniform deposition, or undesired migration of the catalyst material. In some instances, after the second drying station 214, the catalyst ink 228 deposited on the surface of the first ion-exchange layer 226 is converted to a water-dissociation catalyst layer 230, and at least a portion of the first ion-exchange layer 226 is coated with the water-dissociation catalyst layer 230. For example, the water-dissociation catalyst layer 230 may not be a continuous layer on the surface of the first ion-exchange layer 226. In other words, the catalyst material in the water-dissociation catalyst layer 230 may be dispersed on the surface of the first ion-exchange layer 226. In some implementations, the water-dissociation catalyst layer 230 is disposed as a distinct layer on the first ion-exchange layer 226. In other implementations, the water-dissociation catalyst layer 230 is distributed at least partially into a surface region of the first ion-exchange layer 226.

As shown in FIG. 2, the fabrication system 200 further includes a third coater 216 configured to deposit a second precursor solution 232 onto the water-dissociation catalyst layer 230 and onto any exposed surface portions of the first ion-exchange layer 226 in response to a non-continuous water-dissociation catalyst layer 230. In some implementations, the third coater 216 may be implemented in a manner similar to the first coater 204 and the second coater 210, or may be selected independently depending on the viscosity, solids loading, and desired wet-film thickness of the second precursor solution 232. For example, the third coater 216 may include a slot-die coater, doctor blade, rod coater, Bird bar, roller coater, knife-over-roll coater, or another film-casting device. The second precursor solution 232 may be delivered to the third coater 216 by one or more pumps, for example a peristaltic pump or a gear pump, and the third coater 216 may include a coating-head alignment system and one or more controls for feed rate, coating width, coating gap, wet-film thickness, and registration relative to the previously formed layers. In some implementations, the second precursor solution 232 is similar in composition to the first precursor solution 224 except that it includes a different ion-exchange material that includes fixed charges of opposite polarity, for example where the first precursor solution 224 forms a CEL and the second precursor solution 232 forms an AEL, or vice versa. In some implementations, the ion-exchange material in the second precursor solution 232 has a concentration in a range of 1 to 50 wt %, 5 to 40 wt %, 10 to 30 wt %, or another suitable range, and has a viscosity in a range of 100 to 12000 cP, 200 to 10000 cP, 500 to 8000 cP, 1500 to 3000 cP, 2500 to 6000 cP, or another suitable range.

In some implementations, the fabrication system 200 further includes a third drying station 220 disposed downstream of the third coater 216. In some implementations, the third drying station 220 is configured to remove at least a portion of the solvent from the second precursor solution 232 so that the second precursor solution 232 is converted into a second ion-exchange layer 234 disposed over the water-dissociation catalyst layer 230 and the exposed surface portion of the first ion-exchange layer 226. The third drying station 220 may be implemented as a hot-air convection oven, infrared heater, drying tunnel with multiple temperature zones, vacuum-assisted dryer, or another drying device. In some implementations, the drying conditions in the third drying station 220 are selected to obtain a target overall membrane thickness, target thicknesses of the first and second ion-exchange layers 226/234, target residual solvent content in the overall BPM, and sufficient interfacial adhesion between the layers while limiting delamination, warping, shrinkage, or curling. After the third drying station 220, the second precursor solution 232 deposited on the surface of the water-dissociation catalyst layer 230 and the exposed surface portion of the first ion-exchange layer 226 is converted to the second ion-exchange layer 234, thereby forming a BPM which includes the first ion-exchange layer 226, the water-dissociation catalyst layer 230, and the second ion-exchange layer 234. The BPM 240 on the substrate 222 is free of added adhesives joining the first ion-exchange layer 226 and the second ion-exchange layer 234.

In some implementations, the BPM 240 has an overall physical thickness of less than 200 μm, less than 100 μm, in a range of 20 to 100 μm, or in a range of 40 to 80 μm, with each of the first and second ion-exchange layers 226, 234 independently having a thickness in a range of 5 to 95 μm. In some implementations, one ion-exchange layer is thinner than the other, for example such that the thickness of the thinner ion-exchange layer is 10%-100% of the thickness of the thicker ion-exchange layer, or 20%-40% of the thickness of the thicker ion-exchange layer.

In some implementations, the fabrication system 200 further includes one or more chill rollers disposed downstream of one or more drying stations to control web temperature and improve web handling, one or more inspection stations configured to monitor coating quality, thickness, defects, and web position, and a rewind unit configured to collect the multilayer structure with controlled roll tension and roll alignment. In some implementations, the fabrication system 200 includes a control system communicably connected to the components of the fabrication system 200 and configured to execute one or more programs to operate the components and devices of the fabrication system 200, for example by controlling web speed, web tension, coating rates, pump rates, drying conditions, and alignment of the coated layers.

Although FIG. 2 depicts the fabrication system 200 as including three coaters 204/210/216 and three drying stages 208/214/220, this arrangement is merely illustrative. In some implementations, fewer coaters and drying stations may be used. For example, a single coater and a single drying station may be used in a repeated manner, with different solutions being selectively supplied to the coater for respective layer-forming operations and the drying unit being operated after each such coating operation. Accordingly, the particular number, sequence, and dedicated use of the coaters and drying stations shown in FIG. 2 are not intended to be limiting.

In some implementations, the ordering of the ion-exchange layers in BPM 240 is selected based on the intended fabrication sequence. For example, BPM 240 may be formed by first forming a CEL on the substrate, forming a water-dissociation catalyst layer on the CEL, and then depositing an AEL over the water-dissociation catalyst layer and the exposed CEL. For another example, the BPM 240 may be formed by first depositing an AEL on the substrate, forming water-dissociation catalyst layer on the AEL, and then depositing the CEL over the water-dissociation catalyst layer and the exposed AEL. Accordingly, references to the first ion-exchange layer 226 and a second ion-exchange layer 234 are not limited to a particular polarity of the fixed charges in the first and second ion-exchange layers 226, 234 unless expressly stated.

FIG. 3 is a flow chart showing aspects of an example fabrication process 300. In some instances, the example fabrication process 300 is a multi-layer casting method that can be used to form a BPM, e.g., the example BPM 100 shown in FIG. 1 or in another manner. The example process 300 presented in FIG. 3 allows for creating a distinct junction between layers, precise controlling over the catalyst loading, precise controlling of layer thickness to within 10-15 μm variation across a roll, tuning of the content of the residual solvent in the polymer, as well as other mechanical, electrochemical, chemical, and optical properties of the BPM. The example process 300 may include additional or different operations, including operations performed by additional or different components, and the operations may be performed in the order shown or in another order. In some implementations, one or more operations in the example process 300 can be performed by operation of a fabrication system (e.g., the fabrication system 200 in FIG. 2) or in another manner.

At 302, a first precursor solution is applied on a surface of the substrate. In some instances, the first precursor solution can be applied to a surface of a substrate by a film-casting process. In some implementations, a film casting device is used to deposit the first precursor solution onto the substrate with a controlled wet thickness and coating uniformity. For example, the film casting device may include a doctor blade, a rod coater, a Mayer rod, a Bird bar, a knife-over-roll coater, a slot-die coater, a curtain coater, a gravure coater, a reverse-roll coater, a comma coater, a spray coater, or another device configured to form a continuous or substantially continuous liquid film. In some implementations, the particular casting device used for casting the first precursor solution may be selected based on one or more properties of the first precursor solution, such as viscosity, solids loading, surface tension, drying behavior, and target coating thickness. In some instances, the film casting devices may be the first coater 204 shown in FIG. 2 or in another manner.

In some implementations, prior to operation 302, the first precursor solution is prepared. For example, the first ion-exchange material containing fixed charges of a first polarity (e.g., positive or negative), which may be in the form of a polymer powder, an ionomer, or another ion-conductive material, may be dissolved, dispersed, or suspended in one or more solvents to form the first precursor solution. In some instances, the one or more solvents used for the precursor solutions include polar protic solvents, polar aprotic solvents, or other solvents capable of solvating or dispersing the corresponding ion-exchange material. For example, suitable solvents may include N,N-dimethylacetamide (DMAc) and N-methyl-2-pyrrolidone (NMP), Dimethyl Sulfoxide (DMSO), MeOH, Ethanol, 1-Propanol, 2 Propanol, Dimethyl carbonate (DMC), 1,4-Dioxane, Methyl Ethyl Ketone (MEK), Tetrahydrofuran (THF), as well as non-polar solvents such as Cyclohexane, or combinations thereof. In some implementations, the first precursor solution is a substantially homogeneous solution or dispersion. The first ion-exchange polymer in the first precursor solution may have a concentration in a range of 1 to 50 wt %, 5 to 40 wt %, 10 to 30 wt %, or another suitable range. In some implementations, the first precursor solution has a viscosity in a range of 100 to 12000 cP, 200 to 10000 cP, 500 to 8000 cP, 1500 to 3000 cP, 2500 to 6000 cP, or another suitable range. In some instances, the first precursor solution may be implemented as the first precursor solution 224 in FIG. 2 or in another manner.

At 304, the first precursor solution is dried to form a first ion-exchange layer. In some implementations, the first precursor solution deposited during sub-operation 302 on the surface of the substrate is dried to form the first ion-exchange layer on the substrate. In some implementations, the drying operation removes at least a portion of the solvent from the deposited first precursor film so that the first ion-exchange material solidifies into a mechanically stable layer that can support subsequent coating of the catalyst ink and the formation of the water-dissociation catalyst layer. The drying may be performed by exposing the deposited first precursor film to ambient conditions or to controlled drying conditions, for example by using one or more heated zones, infrared heaters, convection ovens, air knives, vacuum-assisted drying units, or other drying devices. In some instances, the drying devices used may be implemented as the first drying station 208 in FIG. 2 or in another manner. In some implementations, the drying conditions, such as temperature, residence time, airflow, humidity, web speed, and pressure, are selected to reduce solvent content while maintaining coating uniformity and limiting formation of defects such as cracking, wrinkling, bubbling, skinning, pinholes, or non-uniform thickness.

In some implementations, operation 304 is controlled so that the resulting first ion-exchange layer is sufficiently dry and mechanically robust to receive the catalyst ink subsequently deposited during operation 306 without substantial dissolution, distortion, or delamination of the first ion-exchange layer. In some instances, operation 304 does not remove all solvent from the first ion-exchange layer, and the resulting first ion-exchange layer may retain a residual solvent content selected to maintain flexibility, adhesion, or interfacial compatibility with subsequently applied layers. In some implementations, the first ion-exchange layer formed in operation 304 may correspond to AEL 102 or CEL 104 shown in FIG. 1, depending on the selected fabrication sequence. In some instances, the first ion-exchange layer may be implemented as the first ion-exchange layer 102, 226 in FIGS. 1-2 or in another manner.

At 306, a catalyst ink is applied on a surface of the first ion-exchange layer. In some instances, the catalyst ink can each be applied to the surface of the first ion-exchange layer by a film-casting process. In some implementations, a film casting device can be used to deposit the catalyst ink onto a previously formed first ion-exchange layer with a controlled wet thickness and coating uniformity. For example, the film casting device may include a doctor blade, a rod coater, a Mayer rod, a Bird bar, a knife-over-roll coater, a slot-die coater, a curtain coater, a gravure coater, a reverse-roll coater, a comma coater, a spray coater, or another device configured to form a continuous or substantially continuous liquid film. In some implementations, the casting device used for depositing the catalyst ink on the surface of the first ion-exchange polymer may be selected based on one or more properties of the catalyst ink, such as viscosity, solids loading, surface tension, drying behavior, and target coating thickness. In some instances, the film casting devices may be implemented as the second coater 210 shown in FIG. 2 or in another manner.

In some instances, the catalyst ink solution may be prepared prior to sub-operation 306. For example, the catalyst ink solution includes a catalyst material, one or more solvents, water, one of the first or second ion-exchange material, or ionomer and an additive such as surface-active agent, dispersing agent and or a rheology modifier or combination. In some implementations, the water-dissociation catalyst material includes one or more transition metal oxides, transition metal oxyhydroxides, transition metal hydroxides, non-metal catalyst, or combinations thereof. In some instances, the catalyst ink includes water in an amount of 1-40 wt % and an organic solvent system including isopropyl alcohol (IPA), for example in an amount of 1-97 wt %. In some implementations, the catalyst ink may further include one or more additional organic solvents, such as N, N-Dimethylacetamide (DMAC), Dimethyl Sulfoxide (DMSO), N-methyl-2-pyrrolidone (NMP), Acetone, Hexane, Dimethyl carbonate, Propylene carbonate, Methyl acetate, Ethanol, Methyl Ethyl Ketone (MEK), or combinations thereof, with a concentration up to 30 wt % for example in a total amount of 0.1-20 wt %. In some implementations, the catalyst ink further includes one or more additives selected from a surface-active agent, a dispersing agent, and a rheology modifier with a concentration of up to 15 wt %. For example, the surface-active agent may include PEG, polysorbats, nonoxynol, pluronics, PGs, PPG, NP-40 Surfact-Amps™ detergent solution, Sorbitan, Tween® 80, etc. up to 15 wt %. In some instances, the dispersing agent such as Solsperse™ SW320, Solsperse™ 45000, Efka® PX 4733, Dispex® Ultra CX 4452, etc. up to 15 wt %. In some instances, the rheology modifier such as Poly acrylates, Carbopol® 940, Solthix™ A100 or another rheology modifier in the catalyst ink. In some instances, the ratio of catalyst material to water in the catalyst ink is in a range of 1:2 to 1:20. In some instances, the first or second ion-exchange material or ionomer is up to 10%. In some instances, the additives such as surface-active agent, dispersing agent or rheology modifier or combination can be up to 15 wt %. In some implementations, the additive content is beneficial because it provides improved wetting, dispersion stability, and rheological control for coating and drying, while preserving the ion-exchange characteristics and structural integrity of the resulting layer. With the additive concentration to less than or equal to 15 wt %, the precursor solution can obtain improved coatability and film uniformity without excessively affecting the composition or performance of the BPM. In some implementations, the catalyst ink has a viscosity in a range of 5 to 250 cP, for example 20 to 100 cP, and has a pH in a range of 1 to 11. In some instances, the catalyst ink may further include the first ion-exchange material, the second ion-exchange material, or both, such that the resulting water-dissociation catalyst layer 306 may be at least partially distributed, dispersed or otherwise embedded into one or both of the first and second ion-exchange layers. In some instances, the catalyst ink may be implemented as the catalyst ink 228 in FIG. 2 or in another manner.

At 308, the catalyst ink is dried to form a water-dissociation catalyst layer. In some implementations, the catalyst ink deposited during operation 306 is dried to form the water-dissociation catalyst layer on the first ion-exchange layer. In some implementations, the drying operation removes at least a portion of water and one or more organic solvents from the catalyst ink so that the catalyst material remains dispersed at or near the surface of the first ion-exchange layer as a distinct catalyst-containing layer. The operation 308 may be performed using one or more of ambient drying, heated drying, convective drying, infrared drying, vacuum drying, or another suitable drying process. In some implementations, the drying conditions are selected to promote formation of a substantially continuous and uniform water-dissociation catalyst layer while limiting agglomeration, cracking, non-uniform deposition, or undesired redistribution of the catalyst material.

In some implementations, operation 308 is controlled so that the water-dissociation catalyst layer remains positioned at the surface of the first ion-exchange layer. In some instances, the drying conditions may be selected such that the water-dissociation catalyst layer is formed as a distinct intermediate layer. In other instances, the drying conditions may permit controlled partial penetration of the catalyst material into the first ion-exchange layer or into the second ion-exchange layer, for example to improve interfacial anchoring and catalyst distribution near the junction. In some instances, the water-dissociation catalyst layer may be implemented as the water-dissociation catalyst layer 106, 230 in FIGS. 1-2 or in another manner.

At 310, a second precursor solution is applied on a surface of the water-dissociation catalyst layer. In some instances, the second precursor solution can be applied to the surface of the water-dissociation catalyst layer by a film-casting process. In some implementations, a film casting device is used to deposit the second precursor solution onto the surface of the water-dissociation catalyst layer with a controlled wet thickness and coating uniformity. For example, the film casting device may include a doctor blade, a rod coater, a Mayer rod, a Bird bar, a knife-over-roll coater, a slot-die coater, a curtain coater, a gravure coater, a reverse-roll coater, a comma coater, a spray coater, or another device configured to form a continuous or substantially continuous liquid film. In some implementations, the particular casting device used for casting the second precursor solution may be selected based on one or more properties of the second precursor solution, such as viscosity, solids loading, surface tension, drying behavior, and target coating thickness. In some instances, the film casting devices may be the third coater 216 shown in FIG. 2 or in another manner.

In some implementations, prior to operation 310, the second precursor solution is prepared. For example, the second ion-exchange material, which may be in the form of a polymer powder, an ionomer, or another ion-conductive material, may be dissolved, dispersed, or suspended in one or more solvents to form the second precursor solution. In some instances, the one or more solvents used for the precursor solutions include polar protic solvents, polar aprotic solvents, or other solvents capable of solvating or dispersing the corresponding ion-exchange material. For example, suitable solvents may include N,N-dimethylacetamide (DMAc) and N-methyl-2-pyrrolidone (NMP), Dimethyl Sulfoxide (DMSO), MeOH, Ethanol, 1-Propanol, 2 Propanol, Dimethyl carbonate (DMC), 1,4-Dioxane, Methyl Ethyl Ketone (MEK), Tetrahydrofuran (THF), as well as non-polar solvents such as Cyclohexane, or combinations thereof. In some implementations, the second precursor solution is a substantially homogeneous solution or dispersion. The second ion-exchange material includes fixed charges of a second polarity opposite to the first polarity of the fixed charges in the first ion-exchange material. The second ion-exchange material in the second precursor solution may have a concentration in a range of 1 to 50 wt %, 5 to 40 wt %, 10 to 30 wt %, or another suitable range. In some implementations, the second precursor solution has a viscosity in a range of 100 to 12000 cP, 200 to 10000 cP, 500 to 8000 cP, 1500 to 3000 cP, 2500 to 6000 cP, or another suitable range. In some implementations, the second precursor solution has a viscosity selected to permit coating and drying without substantial intermixing with the water-dissociation catalyst layer or the previously formed ion-exchange layer. In some instances, the second precursor solution may be implemented as the second precursor solution 232 in FIG. 2 or in another manner.

At 312, the second precursor solution is dried to form a second ion-exchange layer. In some implementations, the second ion-exchange layer formed in operation 312 may correspond to AEL 102 or CEL 104, depending on the selected fabrication sequence. In some implementations, the second precursor solution deposited during sub-operation 312 is dried to form the second ion-exchange layer on the water-dissociation catalyst layer and in some instances, on the exposed surfaces of the first ion-exchange layer. In some implementations, the drying operation removes at least a portion of the solvent from the deposited second precursor film so that the second ion-exchange material solidifies into a mechanically stable layer. The drying process may be performed by exposing the deposited precursor film to ambient conditions or to controlled drying conditions, for example by using one or more heated zones, infrared heaters, convection ovens, air knives, vacuum-assisted drying units, or other drying devices. In some instances, the drying devices used may be implemented as the third drying station 220 in FIG. 2 or in another manner. In some implementations, the drying conditions, such as temperature, residence time, airflow, humidity, web speed, and pressure, are selected to reduce solvent content while maintaining coating uniformity and limiting formation of defects such as cracking, wrinkling, bubbling, skinning, pinholes, or non-uniform thickness.

In some implementations, operation 312 is controlled so that the resulting second ion-exchange layer is sufficiently dry and mechanically robust. In some instances, operation 312 does not remove all solvent from the second ion-exchange layer, and the dried layer may retain a residual solvent content selected to maintain flexibility, adhesion, or interfacial compatibility with subsequently applied layers. In some implementations, operation 312 may also remove a portion of the solvent from the first ion-exchange layer. In some implementations, the drying conditions used in operation 312 are selected to achieve a desired final membrane thickness, residual solvent content, interfacial integrity, and mechanical stability of the BPM. In some implementations, operation 312 is controlled to limit delamination, curling, warping, excessive shrinkage, or other dimensional instability as the second precursor layer dries and bonds with the underlying structure (e.g., the water-dissociation catalyst layer and the first ion-exchange layer). In some implementations, the resulting BPM is mechanically robust to be separated from the substrate, and chemically stable to be stored in a dry state, and later incorporated into an electrochemical stack (e.g., the electrochemical stacks 900 and 930 shown in FIGS. 9A-9B). In some instances, the second ion-exchange layer may be implemented as the second ion-exchange layer 104, 234 in FIGS. 1-2 or in another manner.

In some implementations, each casting step 302, 306, 310 is performed such that the applied liquid composition wets the underlying surface sufficiently to form a substantially uniform coating while limiting defects such as streaking, ribbing, pinholes, voids, dewetting, or excessive intermixing between adjacent layers. In some implementations, one or more coating parameters are controlled during the casting step 302, 306, 310 in order to obtain a desired layer structure and membrane performance. For example, the gap height of a doctor blade or slot die, line speed, solution feed rate, coating pressure, substrate speed, substrate tension, coating temperature, ambient humidity, or another casting parameter may be selected to control wet-film thickness, coating width, coating uniformity, and final dried thickness of the corresponding layer. In some implementations, the casting steps 302, 306, 310 and drying steps 304, 308, 312 are performed as part of a roll-to-roll manufacturing process in which the substrate moves continuously or intermittently through one or more coating stations and drying stations. In other implementations, one or more of the layers may be cast in a batch process or sheet-based process. By controlling the casting and drying conditions for the first precursor solution, the catalyst ink, and the second precursor solution, the resulting BPM can be formed with desired thicknesses, interfacial contact, catalyst loading, and overall structural uniformity.

In some implementations, the casting process can be configured so that the water-dissociation catalyst layer remains as a distinct layer between the two ion-exchange layers. In some instances, the casting conditions may instead be selected to allow partial penetration or interfacial mixing of the catalyst ink with one or both adjacent precursor layers, for example to anchor the catalyst material at the junction region between the ion-exchange layers. Accordingly, the casting process may be selected not only to deposit material, but also to tailor the morphology, continuity, and interface quality of the resulting multilayer BPM structure. During operation 308, the catalyst ink can be cast onto the surface of the first ion-exchange layer and heated at an elevated temperature (of at least about 100 °C) for a time period (e.g., at least 1 minute, at least 2 minutes, at least 5 minutes, or another time period) to dry the catalyst ink. In some implementations, the sub-operations 306, 308 may be repeated until a predetermined catalyst mass loading is obtained.

In some implementations, operations 304, 308, 312 may be carried out in separate drying stations arranged along a roll-to-roll process line. In other implementations, two or more of operations 304, 308, 312 may be performed using a shared drying station or a multi-zone drying system. In some instances, the drying conditions for the respective layers are independently selected because the first precursor solution, the catalyst ink, and the second precursor solution may differ in viscosity, solvent composition, solids loading, wet-film thickness, and target residual solvent content. By independently controlling drying operations 304, 308, 312, the manufacturing process can be used to tailor the thickness, adhesion, residual solvent content, catalyst distribution, and overall performance of the BPM.

In some implementations, drying conditions in the respective drying stations are selected so that, following drying, the first ion-exchange layer retains a residual solvent content of less than 15 wt %, less than 10 wt %, or in a range of 5-15 wt %; the second ion-exchange layer retains a residual solvent content of less than 30 wt %, less than 20 wt %, or in a range of 10-30 wt %; and the finished BPM, after separation from the substrate, retains a residual solvent content of less than 30 wt %, less than 20 wt %, or in a range of 10-20 wt %. In some instances, the BPM can be characterized and processing conditions of the example process 300 can be adjusted. For example, residual solvent content may be determined for an individual layer or for the finished BPM by thermogravimetric analysis, loss-on-drying, gas chromatography, or another suitable analytical technique after equilibration under a predetermined ambient condition.

In some implementations, after applying the first and/or the second precursor solutions at operations 302, 310, a reinforcement structure can be applied to the respective deposited precursor films. In some instances, the reinforcement structure may include a mesh, woven fabric, nonwoven scrim, porous polymer film, expanded fluoropolymer film, microporous substrate, or glass-fiber network. After drying, the reinforcement structure is embedded in the first ion-exchange layer, the second ion-exchange layer, and/or extends into the junction region. In some instances, the reinforcement structure is configured to improve web handling during roll-to-roll processing, increase tear resistance, and increase dimensional stability of the BPM.

In some implementations, the resulting BPM on the substrate may be collected in roll form, cut into sheets or smaller pieces, and handled or transported in a dry state. In some implementations, the BPM produced by the example process 300 does not require hydrated storage for maintaining membrane integrity prior to use. The BPM can be separated from the substrate before being assembled into an electrochemical stack. In some implementations, separation from the substrate can be handled without substantial tearing, stretching, distortion, or delamination. In some implementations, the first ion-exchange layer, the second ion-exchange layer, and the water-dissociation catalyst layer maintain their relative positions and interfacial contact after removal from the substrate. For example, the BPM may be peeled, lifted, released, or otherwise detached from the substrate as a continuous sheet or web.

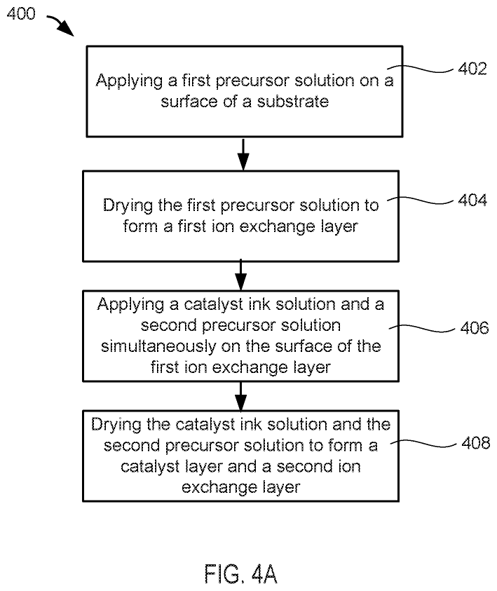

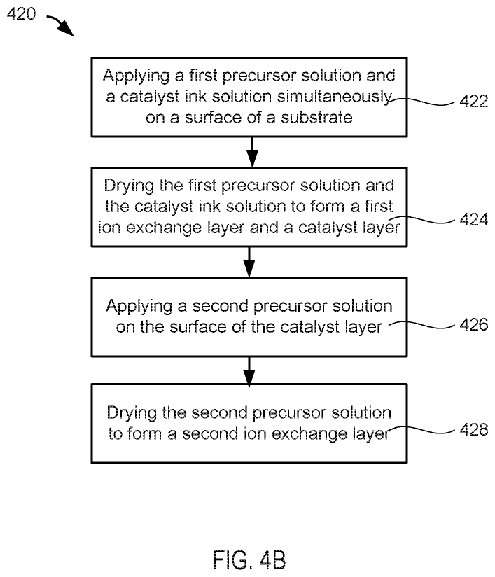

FIG. 4A is a flow chart showing aspects of an example fabrication process 400. In some implementations, the example fabrication process 400 is a multilayer casting method that can be used to form a BPM, for example, the BPM 100 shown in FIG. 1 or another BPM. In some implementations, the BPM formed using the example process 400 includes a first ion-exchange layer, a second ion-exchange layer, and a water-dissociation catalyst layer dispersed at a junction between the first ion-exchange layer and the second ion-exchange layer. In some implementations, the first ion-exchange layer may be either an anion-exchange layer or a cation-exchange layer with fixed charges of a first polarity, and the second ion-exchange layer may be the other of the anion-exchange layer and the cation-exchange layer with fixed charges of a second polarity opposite to the first polarity. In some implementations, the example process 400 enables controlled formation of the multilayer BPM structure with precise control over layer thickness, catalyst distribution, junction quality, and properties of the BPM. The example process 400 can enable continuous manufacturing of BPMs on a substrate, allowing for low-cost production of high performance BPMs at high speed and at large scale. The example process 400 may include additional or different operations, including operations performed by additional or different components, and the operations may be performed in the order shown or in another order. In some implementations, one or more operations in the example process 400 can be performed by operation of a fabrication system, for example the fabrication system 200 shown in FIG. 2, or in another manner.

At 402, a first precursor solution is applied on a surface of a substrate. In some implementations, the first precursor solution is applied by a film-casting process, for example by slot-die coating, doctor-blade coating, rod coating, or another coating technique. At 404, the first precursor solution is dried to form the first ion-exchange layer. In some implementations, the drying conditions used in operation 404 are selected to form the first ion-exchange layer. In some instances, operation 402 and 404 may be implemented as the respective operation 302, 304 in the example process 300 shown in FIG. 3 or in another manner. In some implementations, the first ion-exchange layer produced from the operations 402, 404 includes a residual solvent with a concentration of less than or equal to 15 wt %, less than or equal to 10 wt %, or in a range of 5 to 15 wt %.

At 406, a catalyst ink and a second precursor solution are applied on a surface of the first ion-exchange layer simultaneously. In some implementations, a double-slot die casting method is used to create two distinct coating layers on the exposed surface of the first ion-exchange layer. In some implementations, operation 406 is performed by operation of a coater of a fabrication system; and the coater includes a double slot die. The double slot die includes a first slot die configured to apply the catalyst ink and a second slot die configured to apply the second precursor solution. In some implementations, the two slot dies are positioned sequentially in a machine direction, for example side-by-side or otherwise in close succession, so that the catalyst ink is applied to the first ion-exchange layer and the second precursor solution is applied over the catalyst ink before substantial drying of the catalyst ink occurs. In some implementations, the substrate coated with the first ion-exchange layer contacts an upstream slot die that applies the catalyst ink and then contacts a downstream slot die that applies the second precursor solution. In some implementations, the relative positions of the slot dies, coating gaps, flow rates, wet-film thicknesses, and line speed are selected such that a relatively thin catalyst-containing layer is formed beneath a thicker second precursor layer while maintaining layer continuity and limiting streaking, ribbing, air entrainment, pinholes, dewetting, or other coating defects.

At 408, the catalyst ink and the second precursor solution are dried to form a water-dissociation catalyst layer and a second ion-exchange layer. In some implementations, the drying conditions are selected such that the second precursor solution forms a mechanically stable second ion-exchange layer and the catalyst ink solution forms a water-dissociation catalyst layer dispersed at or near an exposed surface of the first ion-exchange layer. In some implementations, operation 408 may be carried out using one or more hot-air convection ovens, infrared heaters, near-infrared lamps, drying tunnels having one or more temperature zones, vacuum-assisted dryers, or combinations thereof. In some implementations, the drying conditions are selected to preserve the positional relationship of the catalyst-containing layer relative to the second ion-exchange layer and to limit undesired intermixing while maintaining good interfacial contact. In some implementations, the BPM formed after operation 408 includes a residual solvent content of less than or equal to 30 wt %, less than or equal to 20 wt %, or in a range of 10 to 20 wt %. In some implementations, operation 408 may be implemented as the operation 308, 312 or in another manner.

FIG. 4B is a flow chart showing aspects of an example fabrication process 420. In some implementations, the example fabrication process 420 is a multilayer casting method that can be used to form a BPM, for example, the BPM 100 shown in FIG. 1 or another BPM. In some implementations, the example process 420 forms a multilayer ion-conductive polymer including a first ion-exchange layer, a second ion-exchange layer, and a water-dissociation catalyst layer dispersed at a junction between the first ion-exchange layer and the second ion-exchange layer. In some implementations, the first ion-exchange layer may be either an anion-exchange layer or a cation-exchange layer with fixed charges of a first polarity, and the second ion-exchange layer may be the other of the anion-exchange layer and the cation-exchange layer with fixed charges of a second, opposite polarity. In some implementations, the example process 420 enables controlled formation of the multilayer BPM structure by first forming a first ion-exchange layer and a catalyst-containing layer in a combined multilayer casting step and then forming the second ion-exchange layer in a subsequent coating step. The example process 420 may include additional or different operations, including operations performed by additional or different components, and the operations may be performed in the order shown or in another order. In some implementations, one or more operations in the example process 420 can be performed by operation of a fabrication system, for example the fabrication system 200 shown in FIG. 2, or in another manner.

At 422, a first precursor solution and a catalyst ink solution are applied on a surface of a substrate simultaneously. In some implementations, a double-slot die casting method is used to create two distinct coating layers on the surface of the substrate. In some implementations, operation 422 is performed by operation of a coater of a fabrication system (e.g., the fabrication system 200 shown in FIG. 2) with a double slot die. The double slot die includes a first slot die configured to apply the first precursor solution and a second slot die configured to apply the catalyst ink solution. In some implementations, the two slot dies are positioned sequentially in a machine direction, for example side-by-side or otherwise in close succession, so that the first precursor solution is first deposited on the substrate and the catalyst ink solution is then deposited over the first precursor solution before substantial drying of the first precursor solution occurs. In some implementations, the substrate contacts an upstream slot die that applies the first precursor solution and then contacts a downstream slot die that applies the catalyst ink solution. In some implementations, the relative positions of the slot dies, coating gaps, flow rates, wet-film thicknesses, and line speed are selected such that the catalyst ink solution forms a relatively thin catalyst-containing layer over the first precursor layer while maintaining layer continuity and limiting streaking, ribbing, air entrainment, pinholes, dewetting, or other coating defects. In some instances, operation 422 may be implemented as operation 406 in FIG. 4A or in another manner.

At 424, the first precursor solution and the catalyst ink solution are dried to form the first ion-exchange layer and the water-dissociation catalyst layer. In some implementations, the drying conditions are selected such that the first precursor solution forms a mechanically stable first ion-exchange layer and the catalyst ink solution forms a water-dissociation catalyst layer dispersed at or near an exposed surface of the first ion-exchange layer. In some implementations, operation 424 may be carried out using one or more hot-air convection ovens, infrared heaters, near-infrared lamps, drying tunnels having one or more temperature zones, vacuum-assisted dryers, or combinations thereof. In some implementations, the drying conditions are selected to preserve the positional relationship of the catalyst-containing layer relative to the first ion-exchange layer and to limit undesired intermixing while maintaining good interfacial contact. In some implementations, the first ion-exchange layer formed after operation 424 includes a residual solvent content of less than or equal to 15 wt %, less than or equal to 10 wt %, or in a range of 5 to 15 wt %. In some implementations, operation 424 may be implemented as the operation 408 in FIG. 4A or in another manner.

At 426, a second precursor solution is applied on a surface of the water-dissociation catalyst layer. In some implementations, the second precursor solution is applied by a film-casting process, for example by slot-die coating, doctor-blade coating, rod coating, or another coating technique. In some implementations, the second precursor solution is also applied on the exposed surfaces of the first ion-exchange layer. In some implementations, operation 426 may be implemented as the operation 310 in FIG. 3 or in another manner.

At 428, the second precursor solution is dried to form the second ion-exchange layer. In some implementations, operation 428 may be implemented as operation 312 in FIG. 3 or in another manner. In some implementations, the drying conditions used in operation 428 are selected to form the second ion-exchange layer over the water-dissociation catalyst layer while maintaining the multilayer BPM structure and limiting delamination, curling, warping, or other dimensional instability. In some implementations, the resulting BPM has an overall residual solvent content of less than or equal to 30 wt %, in a range of 10 to 20 wt %, or in another range, and may be separated from the substrate and handled or stored in a dry state without requiring hydrated storage.

FIGS. 5A-5C are schematic diagrams showing aspects of example BPMs 500, 510, 520. In some implementations, the example BPMs 500, 510, 520 are multilayer ion-conductive polymers which include a first ion-exchange layer 502, 512, 522 containing fixed charges of a first polarity, a second ion-exchange layer 504, 514, 524 containing fixed charges of a second, opposite polarity. Each of the BPMs 500, 510, 520 includes a water-dissociation catalyst material 506 distributed within at least one ion-exchange layer 502, 512, 522, 504, 514, 524 of the BPM 500, 510, 520. In some instances, the water-dissociation catalyst material 506 may include one or more transition metal oxides, oxyhydroxides, hydroxides, non-metal catalysts, or combinations thereof.

As shown in FIG. 5A, the example BPM 500 includes a first ion-exchange layer 502 and a second ion-exchange layer 504. The BPM 500 further includes a catalyst material 506 distributed within the first ion-exchange layer 502. In some implementations, the first ion-exchange layer 502 is formed from a first precursor solution that includes both a first ion-exchange material and the catalyst material 506. In some instances, the second ion-exchange layer 504 is formed from a second precursor solution that includes a second ion-exchange material having fixed charges of opposite polarity relative to the fixed charges in the first ion-exchange layer 502 and does not include the catalyst material 506, or includes less catalyst material than the first ion-exchange layer 502. In some implementations, the catalyst material 506 may also be positioned sufficiently close to the interface between the first ion-exchange layer 502 and the second ion-exchange layer 504 to promote water dissociation during operation of the BPM 500 in an electrochemical stack.

In some implementations, the catalyst material 506 shown in FIG. 5A as dispersed throughout the first ion-exchange layer 502 is not necessarily distributed uniformly through the full thickness of the first ion-exchange layer 502. For example, the catalyst material 506 may be present at a greater concentration in a surface region of the first ion-exchange layer 502 adjacent to the interface with the second ion-exchange layer 504, while a lower concentration of the catalyst material 506 is present farther from the interface. In some instances, a portion of the catalyst material 506 may extend to the interface or be partially exposed at the interface after drying, thereby defining a catalyst-enriched junction region between the first and second ion-exchange layers 502, 504.

As shown in FIG. 5B, the example BPM 510 includes the first ion-exchange layer 512 and a second ion-exchange layer 514. The BPM 510 further includes a catalyst material 506 distributed within the second ion-exchange layer 514. In some implementations, the first ion-exchange layer 512 is formed from a first precursor solution that does not include the catalyst material 506, or includes less catalyst material than the second ion-exchange layer 514, while the second ion-exchange layer 514 is formed from a second precursor solution that includes both a second ion-exchange material and the catalyst material 506. In some instances, the second ion-exchange layer 514 includes fixed charges of opposite polarity relative to fixed charges in the first ion-exchange layer 512. In some implementations, the catalyst material 506 may be distributed within a region of the second ion-exchange layer 514 adjacent to the interface between the first and second ion-exchange layers 512, 514, thereby defining a catalyst-containing junction region without requiring a separately cast catalyst-only layer.

As shown in FIG. 5C, the example BPM 520 includes a first ion-exchange layer 522 and a second ion-exchange layer 524. The BPM 520 further includes catalyst material 506 distributed within both the first ion-exchange layer 522 and the second ion-exchange layer 524. In some implementations, the first precursor solution used to form the first ion-exchange layer 522 includes a first ion-exchange material and catalyst material 506, and the second precursor solution used to form the second ion-exchange layer 524 includes a second ion-exchange material and catalyst material 506. In some instances, the catalyst material 506 in the first ion-exchange layer 522 and the catalyst material 506 in the second ion-exchange layer 524 may have the same composition or different compositions and may be present in the same or different amounts in the respective ion-exchange layers. In some implementations, the catalyst-containing regions in the first and second ion-exchange layers 522 and 524 together define a junction region that promotes water dissociation while maintaining a two-layer membrane structure.

In some implementations, the catalyst material 506 distributed within an ion-exchange layer may be present as a discontinuous dispersed phase within a continuous ion-exchange polymer matrix. For example, the catalyst material 506 may be present as discrete particles, nanoparticles, microparticles, agglomerates, platelet-like or flake-like domains, porous clusters, fibers, or other catalyst-containing domains embedded in the ion-exchange layer. In some instances, the catalyst material 506 may be substantially randomly dispersed, may be arranged with a concentration gradient through the thickness of the ion-exchange layer, or may be enriched in a region adjacent the interface with the opposing ion-exchange layer. In some implementations, individual catalyst-containing domains may remain isolated from one another, may partially contact one another to form tortuous or partially percolated pathways, or may define an interpenetrating or three-dimensional entangled junction region having increased interfacial area. In some examples, the catalyst material 506 may be dispersed between polymer fibers, along polymer fibrils, as multilayer deposits on internal surfaces, or in microscale protrusions extending from one layer toward the other layer. Accordingly, the physical geometry and morphology of the catalyst material 506 within the ion-exchange layer may be selected to tailor local interfacial areas, water access, ionic transport, adhesion between adjacent layers, and water-dissociation performance.

In some implementations, the BPMs 500, 510, 520 shown in FIGS. 5A-5C may each be formed as freestanding membranes, may be free of added adhesives joining the ion-exchange layers, and may be stable in a dry form for handling, storage, transport, and later incorporation into an electrochemical stack. In some instances, the ion-exchange layers in the BPMs 500, 510, 520 may be selected from an anion-exchange layer and a cation-exchange layer in either order. For example, the first ion-exchange layer 502, 512, 522 may be an anion-exchange layer and the second ion-exchange layer 504, 514, 524 may be a cation-exchange layer, or vice versa. Accordingly, the relative positions of the layers shown in FIGS. 5A-5C are illustrative and are not intended to be limiting as to polarity or order unless expressly stated.

In some implementations, the BPMs 500, 510, 520 include residual solvent in one or both ion-exchange layers. For example, in the BPM 500 of FIG. 5A, the first ion-exchange layer 502 containing the catalyst material 506 may retain residual solvent after drying; in the BPM 510 of FIG. 5B, the second ion-exchange layer 514 containing the catalyst material 506 may retain residual solvent after drying; and in the BPM 520 of FIG. 5C, each of the first and second ion-exchange layers 522, 524 containing the catalyst material 506 may retain residual solvent after drying. In some implementations, the residual solvent content of a catalyst-containing ion-exchange layer is selected to maintain flexibility, interfacial adhesion, and mechanical robustness while limiting excessive swelling, softening, or deformation. In some implementations, the residual solvent content of one or both ion-exchange layers in the BPMs 500, 510, 520 is less than 30 wt %, less than or equal to 20 wt %, less than or equal to 15 wt %, in a range of 5 to 15 wt %, or in another range. In some implementations, the overall residual solvent content of the BPM 500, 510, or 520 is less than or equal to 30 wt %, less than or equal to 20 wt %, in a range of 10 to 20 wt %, or in another range.

In some implementations, the BPMs 500, 510, 520 each have an overall physical thickness, measured through the thickness direction from one outer surface of the membrane to the opposite outer surface, of less than 200 μm, less than or equal to 100 μm, in a range of 20 to 100 μm, or in a range of 40 to 80 μm. In some implementations, the overall thickness of the BPM 500, 510, or 520 corresponds to the combined thicknesses of the first and second ion-exchange layers together with the thickness contribution, if any, of the catalyst-containing regions distributed within one or both of the ion-exchange layers. In some implementations, each ion-exchange layer independently has a thickness in a range of 5 to 95 μm. In some examples, one ion-exchange layer is thinner than the other such that the thickness of the thinner ion-exchange layer is 10% to 100% of the thickness of the thicker ion-exchange layer, or 20% to 40% of the thickness of the thicker ion-exchange layer. Unless otherwise specified, the foregoing thicknesses may refer to the BPM in a dry state.

In some implementations, the BPMs 500, 510, 520 are free of added adhesives joining the first ion-exchange layer and the second ion-exchange layer. In some instances, the catalyst material 506 dispersed in one or both ion-exchange layers can contribute to interfacial adhesion and to anchoring of the junction region between the ion-exchange layers, for example by increasing interfacial contact area and by mechanically integrating the catalyst-containing region with the surrounding ion-exchange polymer. In some implementations, the BPMs 500, 510, 520 are stable in a dry form and do not require hydrated storage. In some instances, the BPMs 500, 510, 520 may be handled, transported, stored, and later incorporated into an electrochemical stack in a dry state.

In some implementations, the BPMs 500, 510, 520 are freestanding membranes without a structural support. In other implementations, the BPM 500, 510, or 520 includes a structural support in at least one of the first ion-exchange layer or the second ion-exchange layer. For example, the structural support may be a reinforcement mesh, woven layer, nonwoven layer, porous fluoropolymer layer, microporous polymer scaffold, or another porous support structure at least partially impregnated with ion-exchange material. In some implementations, the structural support is configured to improve tear resistance, dimensional stability, web handling, and mechanical robustness while allowing the BPM 500, 510, 520 to maintain ionic conductivity and a relatively low thickness.

In some implementations, the first and second ion-exchange layers 502/504, 512/514, 522/524 of the BPMs 500, 510, 520 are selected such that the BPM remains mechanically stable during hydration, dehydration, and electrochemical operation. For example, each of the ion-exchange layers may have an ion-exchange capacity in a range of 0.5 to 3 milliequivalents per gram, or another suitable range. In some implementations, each of the first and second ion-exchange layers has a swelling of less than 10% in solution, and the swelling of the first and second ion-exchange layers is matched or sufficiently similar to reduce internal stress, curling, warping, cracking, or delamination. In this manner, the BPMs 500, 510, 520 can maintain structural integrity and stable interfacial contact even when the catalyst material 506 is distributed within one or both ion-exchange layers.

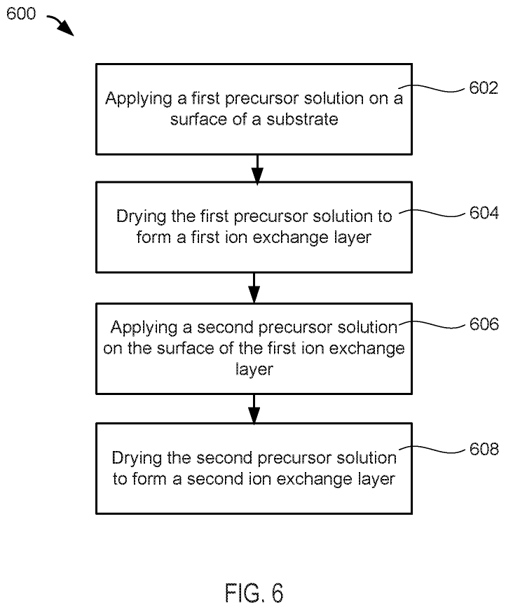

FIG. 6 is a flow chart showing aspects of an example process 600. In some implementations, the example fabrication process 600 is a multilayer casting method that can be used to form the example BPMs 500, 510, 520 shown in FIGS. 5A-5C or another BPM in which water-dissociation catalyst material is incorporated into at least one ion-exchange layer. In some implementations, unlike process 300, 400, 420 of FIGS. 3 and 4A-4B, the example process 600 does not include a separate coating step dedicated to forming a distinct catalyst-only layer between two previously formed ion-exchange layers. Instead, the catalyst material is incorporated into at least one of the precursor solutions used to form the ion-exchange layers, such that a catalyst-containing junction region is created when the first and second ion-exchange layers are formed and brought into interfacial contact.

At 602, a first precursor solution is applied on a surface of a substrate. In some implementations, the first precursor solution includes a first ion-exchange material containing fixed charges of a first polarity and one or more solvents. In some instances, the first precursor solution further includes water-dissociation catalyst material dispersed therein, for example to form the catalyst-containing first ion-exchange layer 502 shown in FIG. 5A or the catalyst-containing first ion-exchange layer 522 shown in FIG. 5C. In some implementations, the first precursor solution may include one or more components otherwise used in a catalyst ink, for example water, IPA, one or more additional organic solvents, one or more additives, or a combination thereof, provided that the composition remains coatable and forms the desired ion-exchange layer after drying. In some instances, the first precursor solution is applied by a film-casting process, for example slot-die coating, doctor-blade coating, rod coating, or another coating technique, and the first precursor solution may be applied using the fabrication system 200 shown in FIG. 2.

At 604, the first precursor solution is dried to form a first ion-exchange layer. In some implementations, drying removes at least a portion of the solvent from the first precursor solution such that the first ion-exchange material solidifies to form a mechanically stable first ion-exchange layer on the substrate. In some instances, where the first precursor solution includes catalyst material, the catalyst material remains distributed within the resulting first ion-exchange layer after drying. In some implementations, the drying conditions are selected such that the catalyst material is retained throughout at least a portion of the first ion-exchange layer and, in some examples, is concentrated in a region adjacent to an exposed surface of the first ion-exchange layer that later contacts the second ion-exchange layer. In some instances, the first ion-exchange layer retains residual solvent after drying to improve flexibility, adhesion, or compatibility with the subsequently applied second precursor solution.

At 606, a second precursor solution is applied on the surface of the first ion-exchange layer. In some implementations, the second precursor solution includes a second ion-exchange material containing fixed charges of a second polarity opposite the first polarity. In some instances, the second precursor solution further includes the catalyst material. For example, when the second precursor solution includes catalyst material and the first precursor solution does not include catalyst material, the process 600 may be used to form the BPM 510 shown in FIG. 5B. When both the first precursor solution and the second precursor solution include catalyst material, the process 600 may be used to form the BPM 520 shown in FIG. 5C. In some implementations, the second precursor solution is selected to wet the exposed surface of the first ion-exchange layer and to form a second ion-exchange layer thereon without requiring a separate catalyst-only coating operation between the two ion-exchange layers.

At 608, the second precursor solution is dried to form a second ion-exchange layer. In some implementations, drying removes at least a portion of the solvent from the second precursor solution so that the second ion-exchange material solidifies to form the second ion-exchange layer on the first ion-exchange layer. In some instances, where the second precursor solution includes catalyst material, the catalyst material remains distributed within the second ion-exchange layer after drying. In some implementations, the drying conditions are selected such that the resulting multilayer structure includes a catalyst-containing junction region at the interface between the first and second ion-exchange layers while maintaining the two-layer membrane structure and limiting excessive delamination, curling, warping, cracking, or non-uniformity. In some implementations, the drying conditions are also selected to obtain a target membrane thickness, target layer-thickness ratio, and selected residual solvent content in one or both ion-exchange layers and/or in the overall BPM.

In some implementations, the example process 600 may be used to produce a BPM having catalyst material distributed in only the first ion-exchange layer, only the second ion-exchange layer, or both ion-exchange layers. Accordingly, the process 600 provides a fabrication approach in which the catalyst-containing junction may be tailored by selection of which precursor solution includes the catalyst material and by selection of the catalyst concentration, solvent system, viscosity, and drying conditions of the corresponding precursor solution.

In some implementations, the resulting BPM produced by process 600 is free of added adhesives joining the first and second ion-exchange layers and can be separated from the substrate as a mechanically robust membrane. In some instances, the resulting BPM can be handled, collected, transported, and stored in a dry state. In some implementations, the process 600 may be performed using separate coaters and drying stations or, as described with respect to FIG. 2, using fewer coating and drying units in a repeated manner with different precursor solutions supplied in sequence. In this way, process 600 can provide a simplified manufacturing route for forming catalyst-containing BPMs while still enabling control over thickness, residual solvent content, interfacial integrity, catalyst distribution, and overall membrane performance.

In some instances, BPM voltage and Faradaic efficiency can be measured using a multi-chamber electrodialysis flow cell configured to isolate performance of the BPM from contributions of electrodes, other membranes, and bulk solution resistance. In some implementations, the BPM is arranged between a cation-exchange membrane (CEM) and an anion-exchange membrane (AEM), with separate acid, base, salt, and electrode chambers configured to receive corresponding solution streams. In some implementations, reference electrodes, for example Ag/AgCl reference electrodes, are positioned in Luggin capillaries on opposite sides of the BPM such that voltage is measured directly across the BPM by a four-point measurement configuration. In this way, the measured BPM voltage can exclude or reduce contributions from electrode overpotential and voltage drops across other membranes and solution compartments. In some implementations, current is applied galvanostatically using a controlled power source. For example, the applied current may be increased through a current-density ramp to characterize voltage as a function of current density, and the BPM may thereafter be operated at a fixed current density to evaluate voltage stability over time.

In some implementations, Faradaic efficiency is determined from acid and/or base production in the solution streams adjacent the BPM after the flow cell reaches steady-state operation. For example, acid and base streams exiting the chambers on opposite sides of the BPM may be collected at selected flow rates, and the concentration of H⁺ and/or OH⁻ in the collected samples may be measured, for example by titration using an auto-titrator. In some implementations, the measured amount or rate of acid and/or base production is compared to the theoretical amount or rate predicted from the applied charge according to Faraday's law to determine the Faradaic efficiency. In this manner, the Faradaic efficiency can indicate how effectively the applied current is converted into useful water dissociation and corresponding acid/base generation at the BPM.

FIGS. 7A-7B include plots 700, 710 showing voltage, with a unit in V, as a function of current density, with a unit in A/m², measured in an electrochemical cell using example BPMs. In some implementations, the electrochemical cell is used to isolate BPM performance from the rest of the cell or stack. In FIG. 7A, curve 702 corresponds to a BPM prepared using the techniques presented here. As shown in FIG. 7A, at a current density of about 800 A/m², the BPM exhibits a voltage of about 0.95 V; and at a current density of about 2000 A/m², the BPM exhibits a voltage of about 1.03 V.

In FIG. 7B, curve 712 corresponds to a first BPM prepared using the techniques presented here having a thickness of about 90 μm, and curve 714 corresponds to the second BPM prepared using the techniques presented here having a thickness of about 60 μm. FIG. 7B also shows that the second, thinner BPM generally exhibits a lower voltage than the first, thicker BPM. For example, at a current density of about 2000 A/m², the first BPM with a thickness of 90 μm exhibits a voltage of about 1.05 V, and the second BPM with a thickness of 60 μm exhibits a voltage of about 0.99 V. In some implementations, the lower voltage of the second, thinner BPM is attributable, at least in part, to reduced ionic resistance while maintaining effective water-dissociation performance.

FIG. 7C includes plots 720 and 722 showing a voltage across a BPM, with a unit in V, as a function of time, with a unit in hours. As shown in FIG. 7C, the BPM voltage remains substantially stable over extended operation. As shown in plot 720, the voltage required to maintain a current density of 800 A/m² remains substantially unchanged over time, varying only between about 1.1 V and about 1.2 V. Similarly, as shown in plot 722, the voltage required to maintain a current density of 2000 A/m² also remains substantially stable over time, e.g., less than 1.5 V. In particular, the voltage to maintain a current density of 2000 A/m² varies only between about 1.3 V and about 1.35 V. The performance shown in FIG. 7C indicates that the BPM can provide stable long-duration operation under electrochemical testing conditions without significant voltage increase over time.

FIG. 7D is a plot 730 showing voltage per triplet, with a unit in V, and faradaic efficiency (FE), with a unit in %, as functions of time, with a unit in hours. In the example shown in FIG. 7D, the solid line 732 represents voltage per triplet and the data points 734 represent FE. As shown in FIG. 7D, the voltage per triplet to sustain a current density of 800 A/m² remains substantially stable over a test period of about 2000 hours, for example at about 1.5 V to about 1.6 V, while the FE remains generally high over the same period, for example in a range of about 80% to about 95%. The faradaic efficiency (FE) shown in FIG. 7D is the water-dissociation efficiency of the repeating membrane unit in the electrodialysis stack. For example, FE may be defined as the percentage of total charge passed through the stack that results in useful generation of H⁺ and OH⁻ ions by water dissociation at the BPM. In some implementations, FE is determined by comparing the measured acid and/or base production to the theoretical acid and/or base production corresponding to the applied current. Thus, FE reflects how efficiently the applied current is used for water dissociation rather than for non-productive ionic transport or other parasitic processes. In some implementations, the data shown in FIG. 7D is obtained using an electrodialysis stack including repeating membrane triplets, for example BPM/CEM/AEM triplets, and demonstrates stable long-term electrodialysis performance of the BPM in a stack environment.

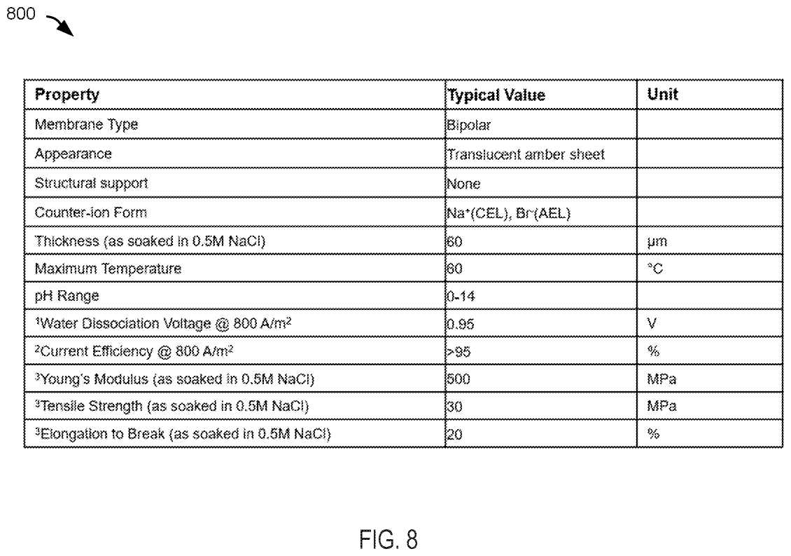

FIG. 8 is a table 800 showing a list of example properties of a BPM prepared using the methods and systems presented here. In the example shown in FIG. 8, the membrane type is bipolar, the appearance is a translucent amber sheet, and the support material is none. The counter-ion form is Na⁺ for the CEL of the BPM and Br⁻ for the AEL of the BPM. The thickness, as soaked in 0.5 M sodium chloride solution, is 60 μm. The maximum operational temperature is 40 °C, and the pH range is 0-14. The water-dissociation voltage at 800 A/m² is 0.95 V, and the current efficiency at 800 A/m² is greater than 95%. The BPM in a wet form (e.g., as soaked in 0.5 M NaCl solution) has a Young's modulus of 500 MPa, a tensile strength of 30 MPa, and the elongation to break of 20%. The values in FIG. 8 indicate that the example BPM can be provided as a relatively thin, freestanding membrane with favorable electrochemical and mechanical properties.

FIG. 9A is a schematic diagram showing aspects of an example electrodialysis unit 900. The example electrodialysis unit 900 includes a stack of layers arranged between an anode 902 and a cathode 904. The stack of ion-exchange membranes is arranged as repeating electrodialysis cells 901 and separated by fluid chambers or channels. The example electrodialysis unit 900 may include additional or different features.

In the example shown in FIG. 9A, the triplet of ion-exchange membranes in each electrodialysis cells 901 includes an anion-exchange membrane (AEM) 906, a cation-exchange membrane (CEM) 908, and a bipolar membrane (BPM) 910. The AEM 906, the CEM 908, and the BPM 910 are semi-permeable membranes that transport certain dissolved ions while blocking transport of other ions. For example, the AEM 906 facilitates the transport of negatively charged ions while blocking the transport of positively charged ions. The CEM 908 facilitates the transport of positively charged ions while blocking the transport of negatively charged ions. The BPM 910 facilitates the transport of both positively charged and negatively charged ions in opposite directions. In various implementations, the electrodialysis unit 900 may include any number of electrodialysis cells 901 such as, for example, one, two, three, four, or more electrodialysis cells 901 (e.g., up to hundreds).

In some aspects of operation, during an electrodialysis process, a potential difference is applied between the anode 902 and the cathode 904 thereby causing the electrodialysis unit 900 to operate in an electric field. A salt solution such as, for example, sodium chloride (NaCl), input seawater, KCl, Na₂SO₄, NaF, NaNO₃, KF, KNO₃, K₂SO₄, or others, can be circulated through internal channels/chambers 918 of an electrodialysis cell 901 between the AEM 906 and the CEM 908. This salt solution may also be circulated through channels 920 between the CEM 908 and the BPM 910 and channels 916 between the AEM 906 and BPM 910. However, salt is not required in these acid and base producing channels. In some implementations, acid or base are circulated in these channels with the balance of solution generally composed of water.

In some instances, the cathode 904 and anode 902 can be made with various materials. Examples of electrode materials include metals, metal alloys, nickel, nickel-based alloys, copper, copper-based alloys, titanium, titanium-based alloys, iron, iron-based alloys, stainless steel, platinum, gold, silver, carbon, carbon cloth, glassy carbon, graphite, and any combinations. In some instances, the anode 902 and cathode 904 can be in various configurations such as foils, films, meshes, layers, coatings, plates, and any combinations. Electrodes can be of various sizes with at least one dimension ranging from 1 mm to about 100 cm. Examples of supporting electrolytes may include NaOH, H₂SO₄, HCl, Na₂SO₄, NaCl—HCl solution, K₄Fe(CN)₆, K₃Fe(CN)₆, FeCl₂, FeCl₃, KOH, K₂CO₃, KHCO₃, NaCl, and any combinations.

In some implementations, the electrodialysis unit 900 is electrically coupled to an external source 922 configured to supply electrical energy to the electrodes 902, 904 and thereby drive acid and base generation in the electrodialysis unit 900. In some instances, the external source 922 may be a DC power supply, a battery, a photovoltaic source such as a solar panel, a rectified AC source, another electrical power source, or a combination thereof. In some implementations, the external source 922 includes or is electrically coupled to power-conditioning circuitry configured to regulate one or more operating parameters, for example voltage, current, power, duty cycle, or polarity, applied to the electrodialysis unit 900. In this way, the external source 922 may provide electrical energy for operating the electrodialysis unit 900 under selected conditions for production of acidic and basic solutions.

In some implementations, application of the electric field causes the water from the channels 916, 920 which has transported into the BPM to dissociate into positively charged hydrogen ions (H⁺) and negatively charged hydroxide ions (OH⁻) within the BPM according to the reaction

2H₂O→H₃O⁺+OH⁻.

In the above reaction, a positively charged hydrogen ion (H⁺) bonds with a water molecule to form the ion H₃O⁺. The positively charged hydrogen (H⁺) ions are transported across the CEL of the BPM 910 into the channel 916 (between the AEM 906 and the BPM 910). The H⁺ ions are blocked from further movement by the AEM 906, the H⁺ concentration in the channel 916 is increased and the pH value of the solution in the channel 916 is reduced.

In similar fashion, application of the electric field also causes the salt present in channel 918 to dissociate into positively charged sodium ions (Na⁺) and negatively charged chlorine ions (Cl⁻) according to the reaction

$$NaCl \to {Na}_{( aq )}^{+} + {Cl}_{( aq )}^{-} .$$

The use of NaCl as an example salt is appropriate for systems in which NaCl would be provided as the feed, such as when ocean water is providing the salt input. In some instances, other salts such as KCl, Na₂SO₄, KF, NaF, NaNO₃, KNO₃, K₂SO₄, or others, could be used, as would be clear to one skilled in the art.

The polarity of the electric field induces movement of the positively charged (H⁺) and (Na⁺) ions towards the cathode 904 and movement of the negatively charged (OH⁻) and (Cl⁻) ions towards the anode 902. However, movement of the ions may be limited by the ion-exchange membranes. The negatively charged hydroxide (OH⁻) ions are transported across the AEL of the BPM 910 into the channel 920. The OH⁻ ions are blocked from further movement by the CEM 908; the OH-concentration in the channel 920 is increased; and the pH value of the solution in the channel 920 is increased.

At the same time, the positively charged sodium (Na⁺) ions are transported across the CEM 908 into the channel 920 from the channel 918, while the negatively charged chlorine (Cl⁻) ions are transported across the AEM 906 into the channel 916. Both the Cl⁻ ions and the Nations are blocked from further movement by the CEL and the AEL, respectively, of the bipolar membrane 910. In channel 916, the Cl-ions combine with the H⁺ ions to form hydrochloric acid (HCl) according to the reaction

[H₃O]⁺+Cl⁻→H₂O+HCl.

In channel 920, the Na⁺ ions combine with the OH⁻ to form sodium hydroxide (NaOH) according to the reaction

Na⁺+OH⁻→NaOH.

As noted previously, as other salts could be used, other acids or bases could also be produced in this manner. For example, if KNO₃ were to be used as the feed salt, HNO₃ and KOH would be the produced acid and base, respectively. Thus, an acidic solution is created in the channel 916 and an alkaline solution is created in the channel 920. A dilute salt stream remains in the channel 918.

In certain instances, the acidic solution from the channel 916 and the alkaline solution from the channel 920 can be collected as product streams and used onsite, stored, transported, or further processed. In some implementations, the acidic and alkaline solutions generated by the electrodialysis unit 900 are used for pH adjustment or neutralization of process streams, regeneration of ion-exchange media, membrane cleaning and descaling, hydrometallurgical leaching, stripping, precipitation, metal-recovery operations, chemical manufacturing, reagent supply, water-treatment processes, mineralization processes, carbon-capture processes, or other industrial processes that use acidic and/or basic solutions. In some examples, direct ocean capture is one such application in which the acidic solution is used to acidify seawater, and the alkaline solution is used to neutralize or alkalinize a treated stream. In some implementations, the acidic and alkaline solutions may be stored separately and later delivered to the electrochemical cell 930 shown in FIG. 9B, where the pH gradient between the stored acidic and alkaline solutions is used to generate electrical energy by electrochemical recombination. In this way, the electrodialysis unit 900 of FIG. 9A and the electrochemical cell 930 of FIG. 9B may be used together as part of an acid/base energy-storage and energy-conversion system.

In some implementations, the electrodialysis cell 900 shown in FIG. 9A, or a stack including multiple electrodialysis cells 900, can be operated to generate acid and base onsite from a salt-containing feed solution, such as seawater or another electrolyte solution. For example, the electrodialysis cell 900 may be implemented in a direct ocean capture (DOC) system in which an acid stream produced by the electrodialysis cell 900 is used to acidify seawater to facilitate conversion of dissolved inorganic carbon to dissolved carbon dioxide for extraction, and a base stream produced by the electrodialysis cell 900 is used to neutralize or alkalinize processed seawater. In other implementations, the electrodialysis cell 900 may be used in other systems in which onsite-generated acid and/or base are used for chemical processing, electrochemical treatment, direct air capture, water treatment, or other purposes. Accordingly, the example electrodialysis cell 900 shown in FIG. 9A is not limited to a particular end-use application.

FIG. 9B is a schematic diagram showing aspects of an example electrochemical cell 930. In some examples, the BPM 910 and associated ion-exchange membranes, for example the AEM 906 and the CEM 908, can be used to extract electrical energy from a pH gradient between acidic and basic solutions in adjacent channels of the electrochemical stack. In some implementations, the electrochemical cell 930 uses the same or substantially the same membrane-stack architecture as the electrodialysis unit 900 shown in FIG. 9A, but is operated in reverse. For example, an acidic solution such as HCl may be supplied to the channel 916 adjacent a cation-exchange side of the BPM 910, and an alkaline solution such as NaOH may be supplied to the channel 920 adjacent to an anion-exchange side of the BPM 910. Recombination of H⁺ and OH⁻ within the BPM 910 forms water and creates an ionic current and voltage across the membrane stack. In some implementations, the recombination of H+ and OH− at the BPM 910 is one part of the ionic conduction through each repeating unit 901, in which sodium ions (Na⁺) are transported across the CEM 908 and chloride ions (Cl⁻) are transported across the AEM 906 so that salt is regenerated in the channel 918. Current generated by the repeating units 901 can be collected at the electrodes 902, 904 and delivered through an external circuit to drive a load 932. In some configurations, the electrical power generated by the electrochemical cell 930 may be conditioned by power electronics and delivered to one or more external loads. Accordingly, the same electrochemical stack architecture used in FIG. 9A for acid and base generation can be operated in reverse in FIG. 9B to consume acid and base and generate electricity.

In some implementations, the electrochemical cell 930 is electrically coupled to a load 932 configured to receive electrical energy generated by the electrochemical cell 930 during recombination of acidic and basic solutions. In some instances, the load 932 may be or include a resistive load, a battery, a capacitor, or other electrical energy-storage device, a motor, a pump, a sensor system, power electronics, another electrically powered device, or a combination thereof. In some implementations, electrical energy generated by the electrochemical cell 930 is delivered directly to the load 932, and in other implementations the electrical energy is conditioned, converted, regulated, stored, or otherwise processed before being delivered to the load 932. Accordingly, the electrochemical cell 930 may be used not only to recover electrical energy from stored acid and base streams, but also to supply that recovered energy to one or more external devices or storage systems

In some aspects of operation, acidic solution and basic solution are introduced into the electrochemical cell 930 and used as reactant streams for power generation. For example, an acidic solution such as HCl can be supplied to the channel 916 disposed between the AEM 906 and the BPM 910, and a basic solution such as NaOH can be supplied to the channel 920 disposed between the CEM 908 and the BPM 910. In some implementations, a salt solution such as NaCl is present in the channel 918 disposed between the CEM 908 and the AEM 906. In some instances, the acidic and basic solutions supplied to the channels 916, 920 may be solutions previously generated by operation of the electrodialysis unit 900 shown in FIG. 9A, such that the same electrochemical stack architecture can be used in a first mode for acid/base production and in a second mode for electrical power generation.

In some implementations, the chemical potential difference between the acidic solution in channel 916 and the basic solution in channel 920 drives ionic transport through the membranes in a direction opposite to the acid/base generation mode of FIG. 9A. For example, hydrogen ions (H⁺) from the acidic solution in channel 916 are transported through the cation-exchange portion of the BPM 910 toward a junction region of the BPM 910, and hydroxide ions (OH⁻) from the basic solution in channel 920 are transported through the anion-exchange portion of the BPM 910 toward the junction region of the BPM 910. At or near the junction of the BPM 910, the H⁺ ions and OH⁻ ions recombine to form water. In this way, the BPM 910 facilitates ionic current through the membrane while consuming the pH gradient stored in the acidic and basic solutions.

At the same time, ions associated with the acidic and basic solutions can be transported through the adjacent monopolar ion-exchange membranes. For example, sodium ions (Na⁺) may be transported from the basic channel 920 across the CEM 908 into the salt channel 918, and chloride ions (Cl⁻) may be transported from the acidic channel 916 across the AEM 906 into the salt channel 918. As a result, salt can be regenerated in the channel 918 while the pH gradient between the acidic and basic channels is reduced. The ionic transport through the BPM 910, the CEM 908, and the AEM 906 establishes an electrochemical potential across the stack, thereby causing electrons to flow through an external circuit between the electrodes 902, 904. In some implementations, the electron flow through the external circuit is used to power the external load 932.

In some implementations, the electrochemical cell 930 operates as an acid-base battery or acid-base energy-conversion device. For example, in a charging or acid/base generation mode corresponding to FIG. 9A, electrical energy can be used to convert a salt solution and water into acidic and basic solutions. In a discharge or power-generation mode corresponding to FIG. 9B, the acidic and basic solutions can later be recombined electrochemically in the same or a similar membrane stack to regenerate salt and water while producing electrical energy. In some instances, the electrical energy generated by the electrochemical cell 930 may be delivered directly to a load 932, stored, conditioned using power electronics, or otherwise used in another system. Accordingly, the example electrochemical cell 930 shown in FIG. 9B demonstrates that the same membrane-stack architecture used for acid/base generation can also be operated in reverse to recover electrical energy from the chemical potential stored in the acid and base streams. Accordingly, the same electrochemical stack architecture can be used in a first mode to generate acid and base and in a second mode to consume acid and base and generate electricity.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

In a general aspect, bipolar membranes are manufactured.

In a first example, a bipolar membrane includes a first ion-exchange layer, a second ion-exchange layer, and a water-dissociation catalyst layer dispersed between the first ion-exchange layer and the second ion-exchange layer. A roll-to-roll manufacturing method for fabricating the bipolar membrane includes advancing a substrate through a plurality of coating and drying stations; applying a first precursor solution on a surface of the substrate; drying the first precursor solution to form the first ion-exchange layer comprising fixed charges of a first polarity; applying a catalyst ink on a surface of the first ion-exchange layer; drying the catalyst ink to form the water-dissociation catalyst layer; applying a second precursor solution on the water-dissociation catalyst layer; and drying the second precursor solution to form the second ion-exchange layer comprising fixed charges of a second, distinct polarity.

Implementations of the first example may include one or more of the following features. The first ion-exchange layer is a cation-exchange layer, and the second ion-exchange layer is an anion-exchange layer. The first ion-exchange layer has a residual solvent content of less than or equal to 15 weight percent. The bipolar membrane has a residual solvent content of less than or equal to 30 weight percent. The bipolar membrane has a residual solvent content in a range of 10 to 20 weight percent. The bipolar membrane has a thickness of less than or equal to 100 micrometers. A thickness of the second ion-exchange layer is 10% to 100% of a thickness of the first ion-exchange layer. The thickness of the second ion-exchange layer is 20% to 40% of the thickness of the first ion-exchange layer.

Implementations of the first example may include one or more of the following features. The catalyst ink includes water, isopropyl alcohol, and a water-dissociation catalyst material. The catalyst ink further includes at least one organic solvent. The first precursor solution includes a first ion-exchange material, the second precursor solution includes a second ion-exchange material, and the catalyst ink includes one of the following: the first ion-exchange material, the second ion-exchange material, or an ionomer with a concentration up to 10 weight percent. A concentration of the first ion-exchange material in the first precursor solution is in a range of 10-50 weight percent, and the first precursor solution has a viscosity in a range of 500-8000 centipoises. The catalyst ink further includes at least one of a surface-active agent, a dispersing agent, or a rheology modifier and a concentration of the at least one of the surface-active agent, the dispersing agent, or the rheology modifier in the catalyst ink is less than 15 weight percent.

Implementations of the first example may include one or more of the following features. The substrate includes a flexible plastic substrate. Each of applying the first precursor solution, applying the catalyst ink, and applying the second precursor solution comprise performing a slot-die casting process. The catalyst ink has a viscosity in a range of 5 to 250 centipoises. The catalyst ink has a viscosity in a range of 20 to 100 centipoises

Implementations of the first example may include one or more of the following features. The bipolar membrane is free of added adhesives joining the first ion-exchange layer and the second ion-exchange layer, and the method further includes storing the bipolar membrane on the substrate in a dry form. Drying the first precursor includes heating the first precursor to remove at least a portion of a solvent in the first precursor. Applying the first precursor solution on the surface of the substrate includes applying the first precursor solution over the surface of the substrate; and after applying the first precursor solution, applying a reinforcement mesh onto the first precursor solution.

In a second example, a roll-to-roll manufacturing method for fabricating a bipolar membrane includes advancing a substrate through a plurality of coating and drying stations; applying a first precursor solution on a surface of the substrate; drying the first precursor solution to form a first ion-exchange layer comprising fixed charges of a first polarity; applying a second precursor solution on a surface of the first ion-exchange layer; and drying the second precursor solution to form a second ion-exchange layer comprising fixed charges of a second, distinct polarity. At least one of the first or second precursor solution comprises a water-dissociation catalyst material dispersed in the at least one of the first or second precursor solutions.

Implementations of the second example may include one or more of the following features. The first precursor solution or second precursor solution includes at least one of a surface-active agent, a dispersing agent, or a rheology modifier with a concentration of less than or equal to 15 weight percent. Each of the first precursor solution and the second precursor solution includes an ion-exchange polymer, a concentration of the ion-exchange polymer in the first precursor solution or the second precursor solution is in a range of 5 to 50 weight percent, and the first precursor solution or the second precursor solution has a viscosity in a range of 500 to 8000 centipoises. The water-dissociation catalyst material includes at least one of transition metal oxide, hydroxide, oxyhydroxide, or non-metal catalyst.

Implementations of the second example may include one or more of the following features. The first precursor solution includes the water-dissociation catalyst material dispersed in the first precursor solution and the second precursor solution comprises no water-dissociation catalyst material. The second precursor solution includes the water-dissociation catalyst material dispersed in the second precursor solution and the first precursor solution includes no water-dissociation catalyst material. Each of the first and second precursor solutions includes the water-dissociation catalyst material dispersed in each of the first and second precursor solutions. The bipolar membrane has a residual solvent content of less than 30 weight percent. The bipolar membrane has a thickness in a range of less than or equal to 100 micrometers. The bipolar membrane is free of added adhesives joining the first ion-exchange layer and the second ion-exchange layer, and the method further includes storing the bipolar membrane on the substrate in a dry form.

In a third example, a bipolar membrane includes a first ion-exchange layer comprising fixed charges of a first polarity; a second ion-exchange layer distinct from the first ion-exchange layer and comprising fixed charges of a second, distinct polarity; and a water-dissociation catalyst layer dispersed between the first ion-exchange layer and the second ion-exchange layer. The bipolar membrane has a thickness of less than or equal to 100 micrometers.

Implementations of the third example may include one or more of the following features. The bipolar membrane has a residual solvent content of less than or equal to 30 weight percent. The bipolar membrane has a residual solvent content of in a range of 10 to 20 weight percent. The thickness of the bipolar membrane is in a range of 40 to 80 micrometers. The bipolar membrane is stable in a dry form and does not require hydrated storage. The bipolar membrane is freestanding without a structural support. The bipolar membrane in a wet form has a Young's modulus in a range of 30 to 1000 megapascals. The bipolar membrane in a wet form has a tensile strength in a range of 15 to 40 megapascals. The bipolar membrane is free of added adhesives joining the first ion-exchange layer and the second ion-exchange layer. The second ion-exchange layer has a thickness in a range of 5 to 95 micrometers.

Implementations of the third example may include one or more of the following features. The bipolar membrane includes a structural support in at least one of the first ion-exchange layer or the second ion-exchange layer. The catalyst material includes a water complex of at least one of transition metal oxide, hydroxide, oxyhydroxide, or non-metal catalyst. The first ion-exchange layer has a thickness in a range of 5 to 95 micrometers. The bipolar membrane has an ion-exchange capacity in a range of 0.5 to 3 milliequivalents per gram. Each of the first and second ion-exchange layers has a swelling of less than 10% in solution, and the swelling of the first and second ion-exchange layers is matched. The water-dissociation catalyst layer has a catalyst loading in a range of 0.01 to 5 grams per square meter. A voltage across the bipolar membrane to drive an ionic current of 800 amperes per square meter is less than 1.2 volt. A voltage across the bipolar membrane to drive an ionic current of 2000 amperes per square meter is less than 1.5 volt. The bipolar membrane has a water dissociation efficiency of greater than or equal to 80%.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A roll-to-roll manufacturing method for fabricating a bipolar membrane comprising a first ion-exchange layer, a second ion-exchange layer, and a water-dissociation catalyst layer dispersed between the first ion-exchange layer and the second ion-exchange layer, the method comprising:
advancing a substrate through a plurality of coating and drying stations;
applying a first precursor solution on a surface of the substrate;
drying the first precursor solution to form the first ion-exchange layer comprising fixed charges of a first polarity;
applying a catalyst ink on a surface of the first ion-exchange layer;
drying the catalyst ink to form the water-dissociation catalyst layer;
applying a second precursor solution on the water-dissociation catalyst layer; and
drying the second precursor solution to form the second ion-exchange layer comprising fixed charges of a second, distinct polarity.

2. The method of claim 1, wherein the first ion-exchange layer is a cation-exchange layer, and the second ion-exchange layer is an anion-exchange layer.

3. The method of claim 1, wherein the first ion-exchange layer has a residual solvent content of less than or equal to 15 weight percent.

4. The method of claim 1, wherein the bipolar membrane has a residual solvent content of less than or equal to 30 weight percent.

5. The method of claim 4, wherein the bipolar membrane has a residual solvent content in a range of 10 to 20 weight percent.

6. The method of claim 1, wherein the bipolar membrane has a thickness of less than or equal to 100 micrometers.

7. The method of claim 1, wherein a thickness of the second ion-exchange layer is 10% to 100% of a thickness of the first ion-exchange layer.

8. The method of claim 7, wherein the thickness of the second ion-exchange layer is 20% to 40% of the thickness of the first ion-exchange layer.

9. The method of claim 1, wherein the catalyst ink comprises water, isopropyl alcohol, and a water-dissociation catalyst material.

10. The method of claim 9, wherein the catalyst ink further comprises at least one organic solvent.

11. The method of claim 9, wherein the first precursor solution comprises a first ion-exchange material, the second precursor solution comprises a second ion-exchange material, and the catalyst ink comprises one of the following: the first ion-exchange material, the second ion-exchange material, or an ionomer with a concentration up to 10 weight percent.

12. The method of claim 11, wherein a concentration of the first ion-exchange material in the first precursor solution is in a range of 10-50 weight percent, and the first precursor solution has a viscosity in a range of 500-8000 centipoises.

13. A roll-to-roll manufacturing method for fabricating a bipolar membrane, the method comprising:
advancing a substrate through a plurality of coating and drying stations;
applying a first precursor solution on a surface of the substrate;
drying the first precursor solution to form a first ion-exchange layer comprising fixed charges of a first polarity;
applying a second precursor solution on a surface of the first ion-exchange layer; and
drying the second precursor solution to form a second ion-exchange layer comprising fixed charges of a second, distinct polarity,
wherein at least one of the first or second precursor solution comprises a water-dissociation catalyst material dispersed in the at least one of the first or second precursor solution.

14. The method of claim 13, wherein the first precursor solution or second precursor solution comprises at least one of a surface-active agent, a dispersing agent, or a rheology modifier with a concentration of less than or equal to 15 weight percent.

15. The method of claim 13, wherein each of the first precursor solution and the second precursor solution comprises an ion-exchange polymer, a concentration of the ion-exchange polymer in the first precursor solution or the second precursor solution is in a range of 5 to 50 weight percent, and the first precursor solution or the second precursor solution has a viscosity in a range of 500 to 8000 centipoises.

16. The method of claim 13, wherein the water-dissociation catalyst material comprises at least one of transition metal oxide, hydroxide, oxyhydroxide, or non-metal catalyst.

17. The method of claim 13, wherein the first precursor solution comprises the water-dissociation catalyst material dispersed in the first precursor solution and the second precursor solution comprises no water-dissociation catalyst material.

18. The method of claim 13, wherein the second precursor solution comprises the water-dissociation catalyst material dispersed in the second precursor solution and the first precursor solution comprises no water-dissociation catalyst material.

19. A bipolar membrane comprising:
a first ion-exchange layer comprising fixed charges of a first polarity;
a second ion-exchange layer distinct from the first ion-exchange layer and comprising fixed charges of a second, distinct polarity; and
a water-dissociation catalyst layer dispersed between the first ion-exchange layer and the second ion-exchange layer,
wherein the bipolar membrane has a thickness of less than or equal to 100 micrometers.

20. The bipolar membrane of claim 19, wherein the bipolar membrane has a residual solvent content of less than or equal to 30 weight percent.
